(19) United States
(12) Patent Application Publication
(10) Pub. No.: US 2026/0222027 A1
(43) Pub. Date: Jul. 30, 2026

(54) CALIBRATION OF MANY WIRELESS DEVICES VIA COORDINATED COMMUNICATIONS

(71) Applicant: QUALCOMM Incorporated, San Diego, CA (US)

(72) Inventors: Vasanthan RAGHAVAN, West Windsor Township, NJ (US); Kobi RAVID, Closter, NJ (US); Junyi LI, Greentown, PA (US)

(21) Appl. No.: 19/145,490

(22) PCT Filed: Feb. 21, 2024
(86) PCT No.: PCT/US2024/016711

§ 371 Date: Jul. 2, 2025

(30) Foreign Application Priority Data
Feb. 22, 2023 (IL) 300849

(51) Int. Cl. H04B 7/06

(52) U.S. Cl. CPC H04B 7/0617

(57) ABSTRACT

Apparatus, methods, and computer program products for antenna calibration are provided. An example method may be performed by a first wireless device including a first plurality of antenna elements of a first quantity and may include establishing a communication link with a second wireless device, where the second wireless device may include a second plurality of antenna elements of a second quantity. The example method may further include, for each respective antenna element of the first plurality of antenna elements, causing transmission, to the second wireless device based on a weight associated with the respective antenna element, of a first set of signals, where a third quantity of signals in the first set of signals is equal to the second quantity.

### TECHNICAL FIELD

The present disclosure relates generally to communication systems, and more particularly, to wireless communication systems with wireless devices to be calibrated.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a first wireless device are provided. The apparatus may include a first plurality of antenna elements of a first quantity, a memory, and at least one processor coupled to the memory. The at least one processor may be configured to establish a communication link with a second wireless device, where the second wireless device includes a second plurality of antenna elements of a second quantity. The at least one processor may be configured to, for each respective antenna element of the first plurality of antenna elements: cause transmission, to the second wireless device based on a weight associated with the respective antenna element, a first set of signals, where a third quantity of signals in the first set of signals is equal to the second quantity, receive, from the second wireless device, a second set of signals, where a fourth quantity of signals in the second set of signals is equal to the second quantity, and where the second set of signals is based on a set of weights respectively associated with the second plurality of antenna elements, and cause transmission, to the second wireless device, feedback information associated with the second set of signals and information indicative of the weight. The at least one processor may be configured to establish a communication link with a second wireless device, where the second wireless device includes a second plurality of antenna elements of a second quantity. The at least one processor may be configured to for each respective antenna element of the second plurality of antenna elements: receive, from the second wireless device based on a weight associated with the respective antenna element, a first set of signals, where a third quantity of signals in the first set of signals is equal to the first quantity, cause transmission, to the second wireless device, a second set of signals, where a fourth quantity of signals in the second set of signals is equal to the first quantity, and where the second set of signals is based on a set of weights respectively associated with the first plurality of antenna elements, and receive, from the second wireless device, feedback information associated with the second set of signals and information indicative of the weight. The at least one processor may be configured to establish a multicast session with a group of wireless devices, where each wireless device in the group of wireless devices includes a respective plurality of antenna elements of a respective quantity of antenna elements. The at least one processor may be configured to cause transmission, to each wireless device in the group of wireless devices, a set of signals, where the set of signals includes a group of subsets of signals, where each subset of signals in the group of subsets of signals is associated with a respective wireless device in the group of wireless devices, and where a respective quantity of signals in the respective subset of signals is equal to the respective quantity of antenna elements. The at least one processor may be configured to receive, from each wireless device in the group of wireless devices, a second set of signals, where a fourth quantity of signals in the second set of signals is equal to the second quantity, and where the second set of signals is based on a respective set of weights respectively associated with the respective quantity of antenna elements. The at least one processor may be configured to cause transmission, to the second wireless device, feedback information associated with the second set of signals and information indicative of the weight.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating two wireless devices communicating with each other based on beams.

FIG. 5 is a diagram illustrating an example of two wireless devices communicating with each other using antennas.

FIG. 6 is a diagram illustrating an example of multiple wireless devices communicating with each other.

FIG. 7 is a diagram illustrating example communications between wireless devices.

FIG. 8 is a diagram illustrating example communications between wireless devices.

FIG. 9 is a diagram illustrating example communications between wireless devices.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a diagram illustrating an example of a hardware implementation for an example apparatus and/or network entity.

FIG. 15 is a diagram illustrating an example of a hardware implementation for an example network entity.

FIG. 16 is a diagram illustrating an example of a hardware implementation for a network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as aNode B (NB), evolved NB (eNB), NR BS, 5GNB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

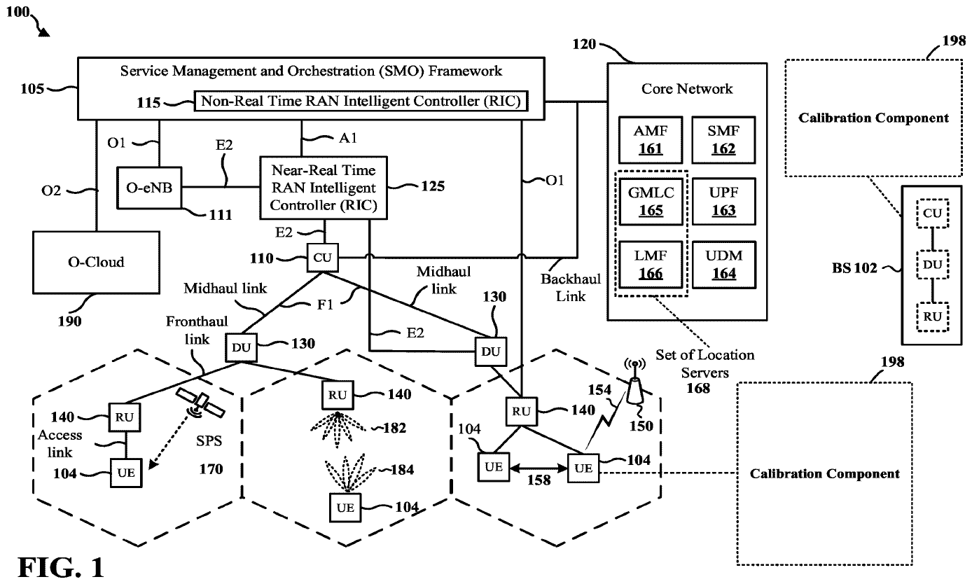

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an AI interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as AI policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5GNR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5GNR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU.

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA). UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 or the base station 102 may include a calibration component 198. The UE 104 or the base station 102 may include a first plurality of antenna elements of a first quantity, a memory, and calibration component 198 coupled to the memory. The calibration component 198 may be configured to establish a communication link with a second wireless device, where the second wireless device includes a second plurality of antenna elements of a second quantity. The calibration component 198 may be configured to, for each respective antenna element of the first plurality of antenna elements: cause transmission, to the second wireless device based on a weight associated with the respective antenna element, a first set of signals, where a third quantity of signals in the first set of signals is equal to the second quantity, receive, from the second wireless device, a second set of signals, where a fourth quantity of signals in the second set of signals is equal to the second quantity, and where the second set of signals is based on a set of weights respectively associated with the second plurality of antenna elements, and cause transmission, to the second wireless device, feedback information associated with the second set of signals and information indicative of the weight. The calibration component 198 may be configured to establish a communication link with a second wireless device, where the second wireless device includes a second plurality of antenna elements of a second quantity. The calibration component 198 may be configured to for each respective antenna element of the second plurality of antenna elements: receive, from the second wireless device based on a weight associated with the respective antenna element, a first set of signals, where a third quantity of signals in the first set of signals is equal to the first quantity, cause transmission, to the second wireless device, a second set of signals, where a fourth quantity of signals in the second set of signals is equal to the first quantity, and where the second set of signals is based on a set of weights respectively associated with the first plurality of antenna elements, and receive, from the second wireless device, feedback information associated with the second set of signals and information indicative of the weight. The calibration component 198 may be configured to establish a multicast session with a group of wireless devices, where each wireless device in the group of wireless devices includes a respective plurality of antenna elements of a respective quantity of antenna elements. The calibration component 198 may be configured to cause transmission, to each wireless device in the group of wireless devices, a set of signals, where the set of signals includes a group of subsets of signals, where each subset of signals in the group of subsets of signals is associated with a respective wireless device in the group of wireless devices, and where a respective quantity of signals in the respective subset of signals is equal to the respective quantity of antenna elements. The calibration component 198 may be configured to receive, from each wireless device in the group of wireless devices, a second set of signals, where a fourth quantity of signals in the second set of signals is equal to the second quantity, and where the second set of signals is based on a respective set of weights respectively associated with the respective quantity of antenna elements. The calibration component 198 may be configured to cause transmission, to the second wireless device, feedback information associated with the second set of signals and information indicative of the weight.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

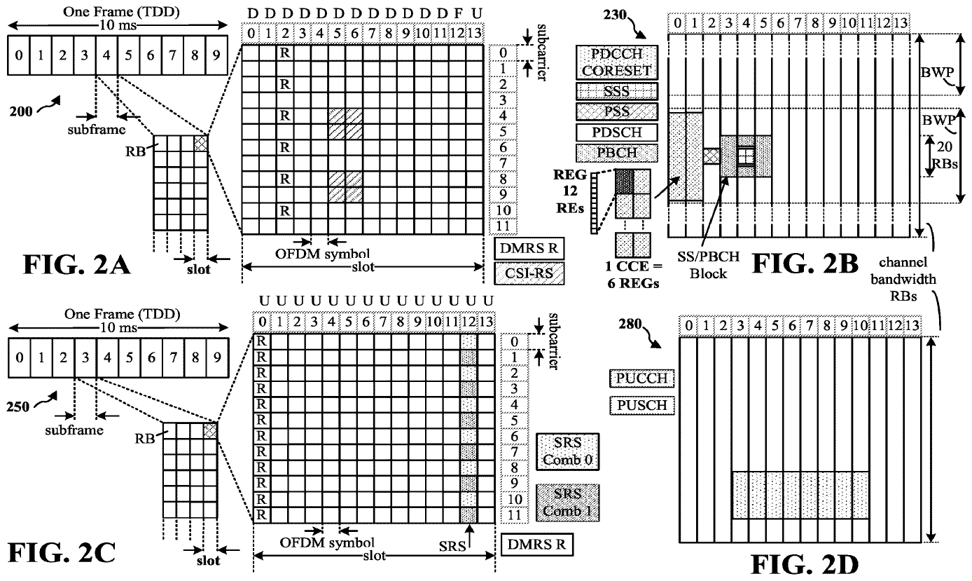

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI).

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

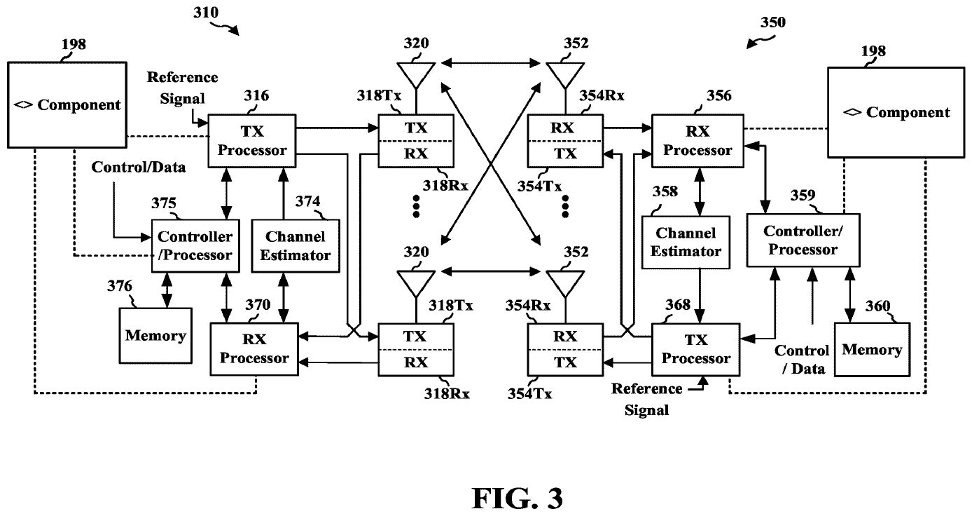

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with calibration component 198 of FIG. 1.

At least one of the TX processor 316, the RX processor 370, and the controller/processor 375 may be configured to perform aspects in connection with calibration component 198 of FIG. 1.

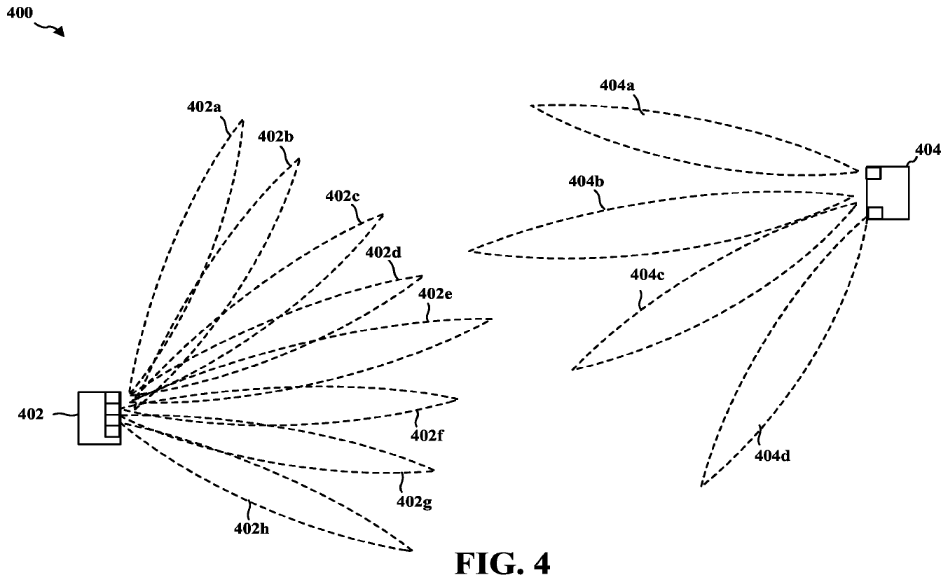

FIG. 4 is a diagram 400 illustrating two wireless devices communicating with each other based on beams. As illustrated in FIG. 4, a wireless device 402 may be in communication with a wireless device 404. Referring to FIG. 4, the wireless device 402 may transmit a beamformed signal to the wireless device 404 in one or more of the directions 402a, 402b, 402c, 402d, 402e, 402f, 402g, 402h. The wireless device 404 may receive the beamformed signal from the wireless device 402 in one or more receive directions 404a, 404b, 404c. 404d. The wireless device 404 may also transmit a beamformed signal to the wireless device 402 in one or more of the directions 404a-404d. The wireless device 402 may receive the beamformed signal from the wireless device 404 in one or more of the receive directions 402a-402h. The wireless device 402/wireless device 404 may perform beam training to determine the best receive and transmit directions (e.g., the best transmit and receive beams) for each of the wireless device 402/wireless device 404. The transmit and receive directions for the wireless device 402 may or may not be the same. The transmit and receive directions for the wireless device 404 may or may not be the same. In one example, the wireless device 402 may initiate beam training by transmitting one or more reference signals (e.g., CSI-RSs, SSBs, etc.) via one or more transmit beams. For each of the transmit beam(s), the wireless device 404 may rotate through its receive beams. For each transmit beam/receive beam pair, the wireless device 404 may generate beam training information. The beam training information may include measurement information. The wireless device 404 may generate the measurement information by performing one or more measurements for a certain metric, such as a signal-to-noise ratio (SNR) metric, a signal-to-interference-plus-noise (SINR) metric, a reference signal received power (RSRP) metric, a received signal strength indicator (RSSI), a spectral efficiency over polarization MIMO (pol-MIMO) metric, or the like. The wireless device 404 may determine a transmit beam/receive beam pair for transmitting and/or receiving signals based on the beam training information. For example, the wireless device 404 may analyze the respective measurement information generated for each transmit beam/receive beam pair and determine which measurement information is representative of the most ideal (e.g., the most optimal or highest) quality with respect to the metric. The wireless device 404 may select the transmit beam/receive beam pair that is associated with such measurement information.

In response to different conditions, the wireless device 404 may determine to switch beams, e.g., between beams 402a-402h. The beam at the wireless device 404 may be used for reception of downlink communication and/or transmission of uplink communication. In some examples, the wireless device 402 may send a transmission that triggers a beam switch by the wireless device 404. For example, the wireless device 402 may indicate a transmission configuration indication (TCI) state change, and in response, the wireless device 404 may switch to a new beam for the new TCI state of the wireless device 402. In some instances, the wireless device 404 may receive a signal, from a base station, configured to trigger a transmission configuration indication (TCI) state change via, for example, a MAC control element (CE) command. The TCJ state change may cause the wireless device 404 to find the best receive beam corresponding to the TCI state from the base station, and switch to such beam. Switching beams may allow for enhanced or improved connection between the UE and the base station by ensuring that the transmitter and receiver use the same configured set of beams for communication.

Millimeter wave beamforming may cover a single or a proximate set of frequencies in FR2 (e.g., bands n257 (ranging between 26.50 GHz-29.50 GHz), n258 (ranging between 24.25 GHz-27.50 GHz), n261 (ranging between 27.50 GHZ-28.35 GHz), bands, n259 (ranging between 39.50 GHZ-43.50 GHz), n260 (ranging between 37.00 GHz-40.00 GHz), etc.). Additional frequencies (e.g., FR3) may also be supported in 5G-advanced, 6G, or the like.

For some wireless communications, such as millimeter wave communications, beamforming may be used to coherently combine energy and overcome the high path losses at higher frequencies. In the receive beamformer, signal from each antenna may be amplified based on a respective “beamforming weight” (which may be referred to as “weight”). Different weights may be used for different channel environments or other situations. In the transmit beamformer, signals that may be transmitted from each antenna element may also be amplified based on a respective beamforming weight (which may be referred to as “weight”). In some aspects, the same weights cannot be reused for reception (Rx) and transmission (Tx) because the RF pathway or circuitry for Tx and Rx may be different. For example, the RF pathway or circuitry may include different sets of amplifiers, mixers, couplers, filters, digital to analog converters (DACs) for Rx or analog to digital converters (ADCs) for Tx, or the like. As used herein, the term “calibration adjustment parameters” may refer to beamforming weight (which may be a vector) and associated other parameters, such as temperature of the modem/chip, power level of the communication, data rate requirements for the communication, or change of frequency of operation, or other parameters that may be used for calibrating an antenna at a wireless device. As one example, calibration adjustment parameters may include an association between weight and other parameters and a wireless device may select beam weights based on other parameters. As used herein, the term “antenna element” may refer to a particular element on an antenna and RF pathway or circuitry associated with the particular element.

Wireless devices, such as UEs, network nodes, or the like, may be calibrated in order to achieve a better result in the communication. For example, calibration may be based on temperature gradient change in the channel, power level of the communication, data rate change for the communication, or change of frequency of operation. In some wireless communication systems, wireless devices may be calibrated based on calibrating each antenna and (each associated circuitry) for Tx and Rx mode based on different test settings before deploying them into a wireless communication system. The number of test settings may be large and such calibration may be costly for the resources. In another example, calibration adjustment parameters may be determined for one sample wireless device and the same calibration adjustment parameters may be reused for all wireless devices that may be categorized as similar to the sample wireless device (e.g., same class, same model, or the like). Aspects provided herein provide an improved calibration method for wireless devices that may be less resource intensive than calibrating each antenna for Tx and Rx mode and may be more accurate than calibration using sample devices.

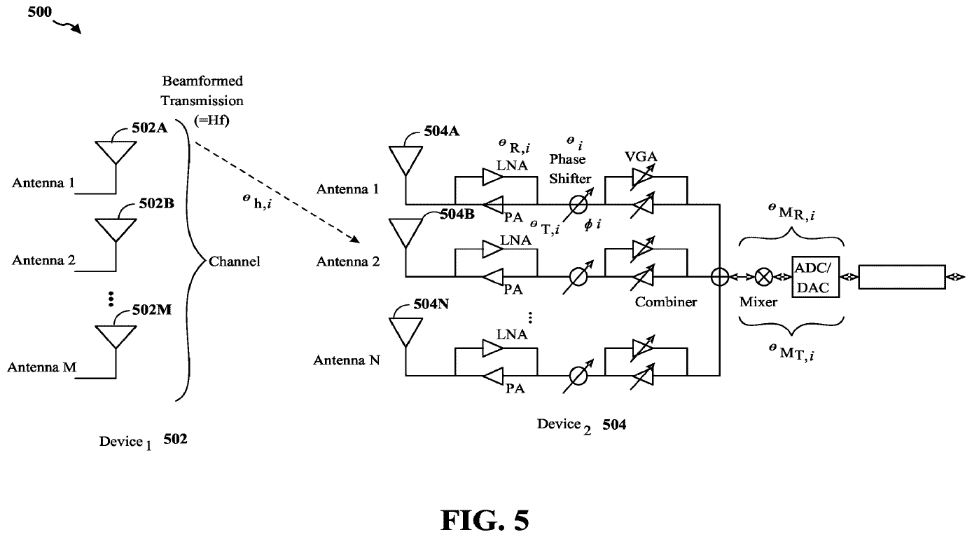

FIG. 5 is a diagram 500 illustrating an example of two wireless devices communicating with each other using antennas. As illustrated in FIG. 5, a first wireless device 502 may include one or more antenna elements including antenna element 502A, antenna element 502B . . . up to antenna element 502M (where M is a positive integer indicative of the total quantity of antenna elements at the first wireless device 502). The first wireless device 502 may be in communication with a second wireless device 504. The second wireless device 504 may include one or more antenna elements including antenna element 504A, antenna element 504B . . . up to antenna element 504N (where N is a positive integer indicative of the total quantity of antenna elements at the second wireless device 504). The one or more antenna elements including antenna element 502A, antenna element 502B . . . up to antenna element 502M may support beamformed transmission with the second wireless device 504. To support each antenna element of the one or more antenna elements including antenna element 504A, antenna element 504B . . . up to antenna element 504N, each antenna element may be associated with power amplifier (PA), low-noise amplifier (LNA), phase shifter, combiner, mixer, variable gain amplifier (VGA), and ADC/DAC, each of which may be calibrated based on calibration adjust parameters.

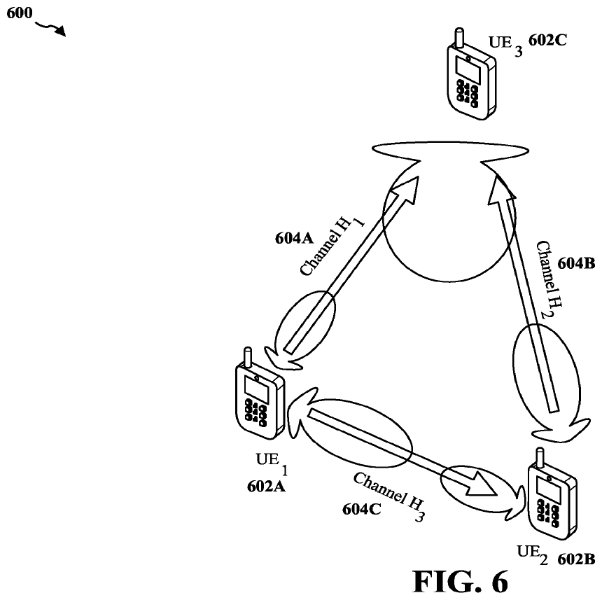

FIG. 6 is a diagram 600 illustrating an example of multiple wireless devices communicating with each other. As illustrated in FIG. 6, a first UE 602A may be in communication with a second UE 602B based on a channel 604C. The first UE 602A may also be in communication with a third UE 602C based on a channel 604A. The third UE 602C may be in communication with the second UE 602B based on a channel 604B. The multiple UEs may intend to communicate with each other with beamformed transmissions. All UEs may have multiple antenna elements that may further calibrated (e.g., operating across different bands/frequencies from which calibration has been done, using different power levels than those calibrated, operating at very different temperature settings than from those calibrated, or the like). Inaccuracies due to lack of calibration may result in poor calibration extrapolation and may lead to beamforming mismatches or losses. Aspects provided herein may enable multiple UEs to calibrate their antenna elements efficiently using reference signals, such as sidelink (SL) sounding reference signal (SRS).

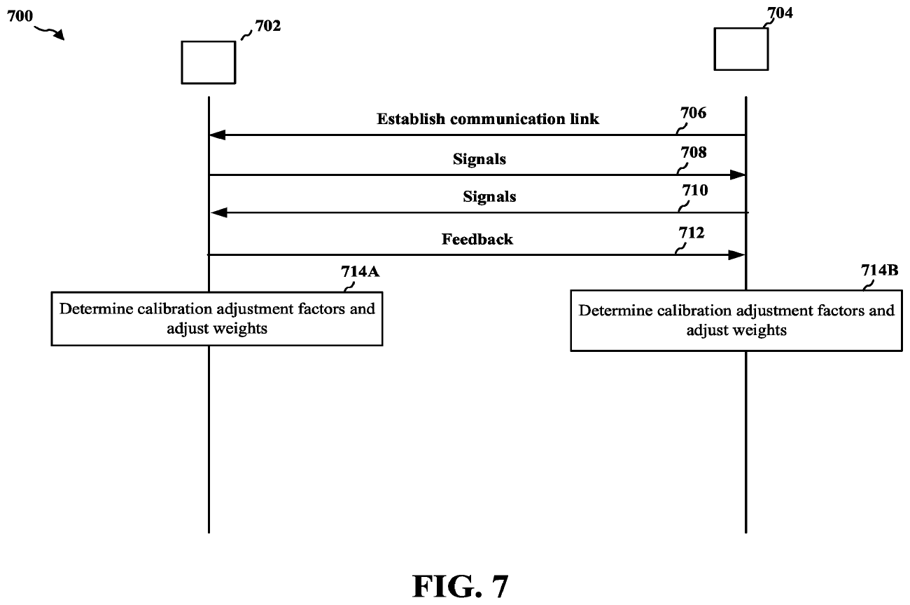

FIG. 7 is a diagram 700 illustrating example communications between wireless devices. As illustrated in FIG. 7, the wireless device 702 may establish a communication link 706 with the wireless device 704. In some aspects, the wireless device 702 may be a UE, a base station, a network node, a network entity, or the like. In some aspects, the wireless device 704 may be a UE, a base station, a network node, a network entity, or the like. In some aspects, the wireless device 702 may establish a communication link 706 with the wireless device 704 based on configuration from a network entity. In some aspects, the wireless device 702 may establish a communication link 706 with the wireless device 704 based on communications between the wireless device 702 and the wireless device 704, and independent of a network entity.

After establishing the communication link 706, the wireless device 702 may transmit a set of signals 708, which may be CSI-RSs, SRSs, or other signals, to the wireless device 704. Upon receiving the set of signals 708, the wireless device 704 may transmit a set of signals 710, which may be CSI-RSs, SRSs, or other signals, to the wireless device 702. In some aspects, the total number of signals in either the set of signals 708 or the set of signals 710 may be equal to M*N (each one-to-one combination of antenna elements at the first wireless device and the second wireless device may be associated with one single signal), where M be a positive integer indicative of the total quantity of antenna elements at the wireless device 702 and N may be positive integer indicative of the total quantity of antenna elements at the wireless device 704. Each of the antenna elements may be associated with a beam and all beams may be associated with a transmitted signal. In some aspects, upon receiving the set of signals 710, the wireless device 702 may transmit feedback information 712, which may include complex scalars, along with the Tx weight used for transmitting the set of signals 708, to the wireless device 704 so that the wireless device 704 may determine calibration adjustment factors (e.g., to perform Rx-Tx circuit path mismatch rectification) and adjust weights accordingly at 714B. In some aspects, the wireless device 702 may determine calibration adjustment factors (e.g., to perform Rx-Tx circuit path mismatch rectification) and adjust weights accordingly at 714A based on the set of signals 708 and the set of signals 710.

As one example, in some aspects, a first wireless device may be transmitting a signal with a beamforming weight, which may be in the form of a beamforming vector f with

$${f}_{i} = {e}^{j {θ}_{i}^{k}} , where {θ}_{i}^{k}$$

may denote the phase used at the i-th antenna at the k-th symbol at the first wireless device. A second wireless device may receive with a beamforming vector g with

$${g}_{i} = {e}^{j {φ}_{i}^{k}} , where {φ}_{i}^{k}$$

may denote the phase used at the i-th antenna at the k-th symbol at the second wireless device. The received complex scalar at the second wireless device when the first wireless device transmits may be:

$${y}^{R , k} = {g}^{H} Hf = {\sum }_{n = 1 , m = 1}^{N , M} {e}^{- j ( {φ}_{n}^{k} + {φ}_{n}^{r} )} \cdot {H}_{nm} {e}^{j ( {θ}_{m}^{k} + {θ}_{m}^{t} )} ,$$

where H may be indicative of the channel matrix. With the first wireless device transmits with a same beamforming vector over K symbols for the set of signals 708, the system equation may be:

$$\begin{matrix}{\underbrace{[ \begin{matrix}{y}_{1}^{R , 1} \\ ⋮ \\ {y}_{1}^{R , K}\end{matrix} ]}}_{K \times 1} = {\underbrace{[ \begin{matrix}{e}^{- j {ϕ}_{1}^{1}} & … & {e}^{- j {ϕ}_{N}^{1}} \\ … & … & … \\ {e}^{- j {ϕ}_{1}^{K}} & … & {e}^{- j {ϕ}_{N}^{K}}\end{matrix} ]}}_{K \times N} \cdot {\underbrace{[ \begin{matrix}{e}^{- j {ϕ}_{1}^{R}} & 0 & … & 0 \\ … & … & … & … \\ 0 & … & 0 & {e}^{- j {ϕ}_{N}^{R}}\end{matrix} ]}}_{N \times N} \cdot {\underbrace{H}}_{N \times M} \cdot {\underbrace{[ \begin{matrix}{e}^{j {ϕ}_{1}^{T}} & 0 & … & 0 \\ … & … & … & … \\ 0 & … & 0 & {e}^{j {ϕ}_{M}^{T}}\end{matrix} ]}}_{M \times M} \cdot {\underbrace{[ \begin{matrix}{e}^{j {ϕ}_{1}^{1}} \\ ⋮ \\ {e}^{j {ϕ}_{M}^{1}}\end{matrix} ]}}_{M \times 1} \\ = {AD}_{1} {HD}_{2} {b}_{1}\end{matrix}$$

Representing the system equation M times over all antenna elements of the first wireless device, the equation may be:

$${\underbrace{[ \begin{matrix}{y}_{1}^{R , 1} & … & {y}_{M}^{R , 1} \\ ⋮ & ⋮ & ⋮ \\ {y}_{1}^{R , K} & … & {y}_{M}^{R , K}\end{matrix} ]}}_{K \times M} = {AD}_{1} {HD}_{2} \cdot [ {b}_{1} … {b}_{M} ]$$

With K=N, the first matrix may include known (e.g., based on signaling between the first wireless device and the second wireless device) beam weights to be used at second device side and may be invertible. With repetition over M times, the second matrix may also be invertible because it may be known by the second wireless device. If the UL and DL channels (e.g., associated with the communication link 706) may be symmetrical, the matrix Y=D₁HD₂ may be known at the second wireless device based on M*N measurements based on the set of signals 708. For the second set of signals 710 transmitted by the second wireless device, the second wireless device may transmit over K beams over M choices of the same first device side beams and may be indicated by the equation below:

$${\underbrace{[ \begin{matrix}{y}_{1}^{T , 1} & … & {y}_{1}^{T , K} \\ ⋮ & ⋮ & ⋮ \\ {y}_{M}^{T , 1} & … & {y}_{M}^{T , K}\end{matrix} ]}}_{M \times K} = {B}^{T} \cdot {\underbrace{[ \begin{matrix}{e}^{j {ϕ}_{1}^{R}} & 0 & … & 0 \\ … & … & … & … \\ 0 & … & 0 & {e}^{j {ϕ}_{M}^{R}}\end{matrix} ]}}_{M \times M} \cdot {H}^{T} \cdot$$

$${\underbrace{[ \begin{matrix}{e}^{- j {ϕ}_{1}^{T}} & 0 & … & 0 \\ … & … & … & … \\ 0 & … & 0 & {e}^{- j {ϕ}_{N}^{T}}\end{matrix} ]}}_{N \times N} \cdot {A}^{T} = {B}^{T} {D}_{2}^{′} {H}^{T} {D}_{1}^{′} {A}^{T}$$

With the feedback information (e.g., 712) of the KM measurements from the first device to the second device, the matrix Z=D₂′H^{T}D₁′ may be known by the second wireless device.

The (i,j)-th entry of Y and the (j,i)-th entry of Z satisfy the following relationship:

$${Y}_{ij} = {c}^{- j {ϕ}_{i}^{R}} {H}_{ij} {e}^{j {θ}_{j}^{T}}$$

$${Z}_{ji} = {e}^{j {θ}_{j}^{R}} {H}_{ij} {e}^{- j {ϕ}_{i}^{T}}$$

$$Thus , {β}_{ij} {=}^{△} ∠ {Y}_{ij} {Z}_{ij}^{*} = {θ}_{j}^{T} - {θ}_{j}^{R} + {φ}_{i}^{T} - {φ}_{i}^{R} .$$

In other words, the phase of YᵢⱼZⱼᵢ* may capture the sum of the Tx-Rx path differentials as seen from the j-th antenna at the first device and the i-th antenna at the second device. Therefore,

$${β}_{ij} - {β}_{i 1} = {θ}_{j}^{T} - {θ}_{j}^{R} - {θ}_{1}^{T} + {θ}_{1}^{R} and {β}_{ij} - {β}_{1 j} = {φ}_{i}^{T} - {φ}_{i}^{R} - {φ}_{1}^{T} + {φ}_{1}^{R} .$$

Based on such equations, the first wireless device and the second wireless device may update (e.g., at 714A or 714B) their beams to capture the Tx-Rx path differentials. For example, the first wireless device may update it's Rx beam weight of the k-th antenna based on the Tx beam weight of the k-th antenna based on:

$$∠ {F}_{k , R} = ∠ {F}_{k , T} - {β}_{ik} + {β}_{i 1} = ∠ {F}_{k , T} - {θ}_{k}^{T} + {θ}_{k}^{R} + {θ}_{1}^{T} - {θ}_{1}^{R} .$$

After the update, a signal received by the first device on the k-th antenna may be adjusted as:

$$∠ {F}_{k , R} - {θ}_{k}^{T} + {θ}_{k}^{R} = ∠ {F}_{k , T} - + {θ}_{1}^{T} - {θ}_{1}^{R} ,$$

which may be invariant to an antenna index and may be calibrated in terms of Tx-Rx path asymmetries via the constant phase offset

$${θ}_{1}^{T} - {θ}_{1}^{R} .$$

The second wireless device may also adjust its own weight based on −βₖᵢ+β₁ᵢ.

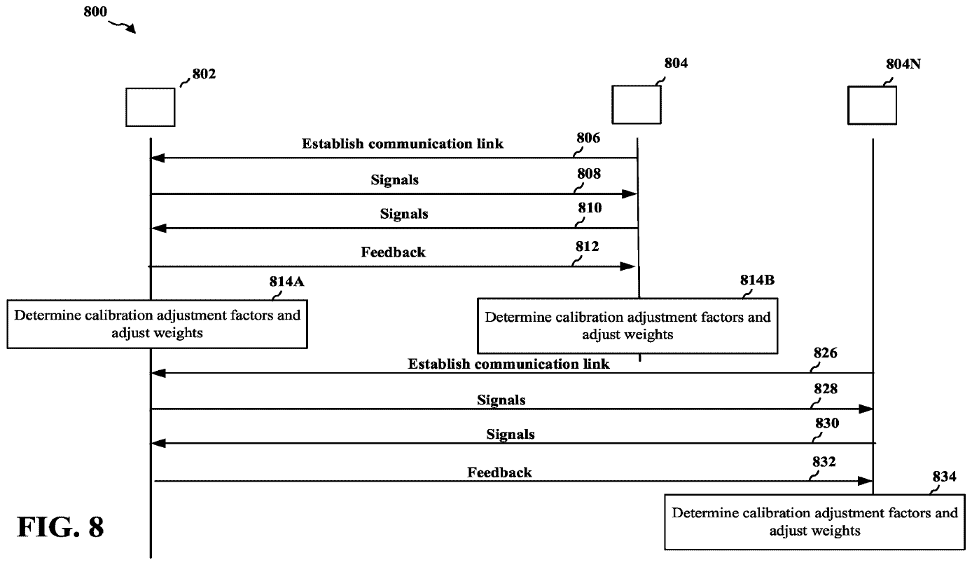

FIG. 8 is a diagram 800 illustrating example communications between wireless devices. As illustrated in FIG. 8, the wireless device 802 may establish a communication link 806 with the wireless device 804. In some aspects, the wireless device 802 may be a UE, a base station, a network node, a network entity, or the like. In some aspects, the wireless device 804 may be a UE, a base station, a network node, a network entity, or the like. In some aspects, the wireless device 802 may establish a communication link 806 with the wireless device 804 based on configuration from a network entity. In some aspects, the wireless device 802 may establish a communication link 806 with the wireless device 804 based on communications between the wireless device 802 and the wireless device 804, and independent of a network entity.

After establishing the communication link 806, the wireless device 802 may transmit a set of signals 808, which may be CSI-RSs, SRSs, or other signals, to the wireless device 804. Upon receiving the set of signals 808, the wireless device 804 may transmit a set of signals 810, which may be CSI-RSs, SRSs, or other signals, to the wireless device 802. In some aspects, the total number of signals in either the set of signals 808 or the set of signals 810 may be equal to M*N, where M be a positive integer indicative of the total quantity of antenna elements at the wireless device 802 and N may be positive integer indicative of the total quantity of antenna elements at the wireless device 804. Each of the antenna elements may be associated with a beam and all beams may be associated with a transmitted signal. In some aspects, upon receiving the set of signals 810, the wireless device 802 may transmit feedback information 812, which may include complex scalars, along with the Tx weight used for transmitting the set of signals 808, to the wireless device 804 so that the wireless device 804 may determine calibration adjustment factors (e.g., to perform Rx-Tx circuit path mismatch rectification) and adjust weights accordingly at 814B. In some aspects, the wireless device 802 may determine calibration adjustment factors (e.g., to perform Rx-Tx circuit path mismatch rectification) and adjust weights accordingly at 814A based on the set of signals 808 and the set of signals 810.

In some aspects, in order to perform calibration for additional wireless devices, calibrations may be performed sequentially. After calibrating the second wireless device 804, an additional wireless device 804N may be calibrated. In some aspects, the additional wireless device 804N may be calibrated concurrently with the wireless device 804 if the potential interference is smaller than a threshold as determined by the wireless device 802, 804, 804N, or the network. As illustrated in FIG. 8, the wireless device 802 may establish a communication link 826 with the wireless device 804N. In some aspects, the wireless device 802 may be a UE, a base station, a network node, a network entity, or the like. In some aspects, the wireless device 804N may be a UE, a base station, a network node, a network entity, or the like. In some aspects, the wireless device 802 may establish a communication link 826 with the wireless device 804N based on configuration from a network entity. In some aspects, the wireless device 802 may establish a communication link 826 with the wireless device 804N based on communications between the wireless device 802 and the wireless device 804N independent of a network entity, based on signaling from the network, or based on pair-wise link budget across the wireless devices.

After establishing the communication link 826, the wireless device 802 may transmit a set of signals 828, which may be CSI-RSs, SRSs, or other signals, to the wireless device 804N. Upon receiving the set of signals 828, the wireless device 804N may transmit a set of signals 830, which may be CSI-RSs, SRSs, or other signals, to the wireless device 802. In some aspects, the total number of signals in either the set of signals 828 or the set of signals 830 may be equal to M*N, where M be a positive integer indicative of the total quantity of antenna elements at the wireless device 802 and N may be positive integer indicative of the total quantity of antenna elements at the wireless device 804N. Each of the antenna elements may be associated with a beam and all beams may be associated with a transmitted signal. In some aspects, upon receiving the set of signals 830, the wireless device 802 may transmit feedback information 832, which may include complex scalars, along with the Tx weight used for transmitting the set of signals 828, to the wireless device 804N so that the wireless device 804N may determine calibration adjustment factors (e.g., to perform Rx-Tx circuit path mismatch rectification) and adjust weights accordingly at 834.

In some aspects, to fully calibrate the first wireless device 802 and the second wireless device 804, the first wireless device 802 may first beamforms with a training beam the second wireless device 804 may scan through M receive beams (M may be a positive integer that is indicative of quantity of antenna elements at the first wireless device 802) associated with the second wireless device 804. The second wireless device 804 may beamform along the set of M training beams while the first wireless device receives with the M receive beams on its end. The first wireless device may provide feedback (e.g., 812) (e.g., which may include complex scalars) to the second wireless device 804 to allow the wireless device 804 to determine an estimate of the Tx-Rx phase mismatch (e.g., at 814B). Such a process may be repeated N times (N may be a positive integer that is indicative of quantity of antenna elements at the second wireless device 804) for all the antenna elements at the second wireless device 804. Therefore, for each additional wireless device 804N (total quantity of additional wireless devices 804N may be indicated by a positive integer K), there may be a 2 KN² number of symbols used. For each wireless device pair, such as wireless device 802 and wireless device 804, wireless device 802 and wireless device 804N, or wireless device 804 and wireless device 804N, there may be a quantity of 2N² number of symbols used for calibration. In some aspects, whether to calibrate with an additional UE 804N may be based on a configuration from a network entity, or independent of network signaling.

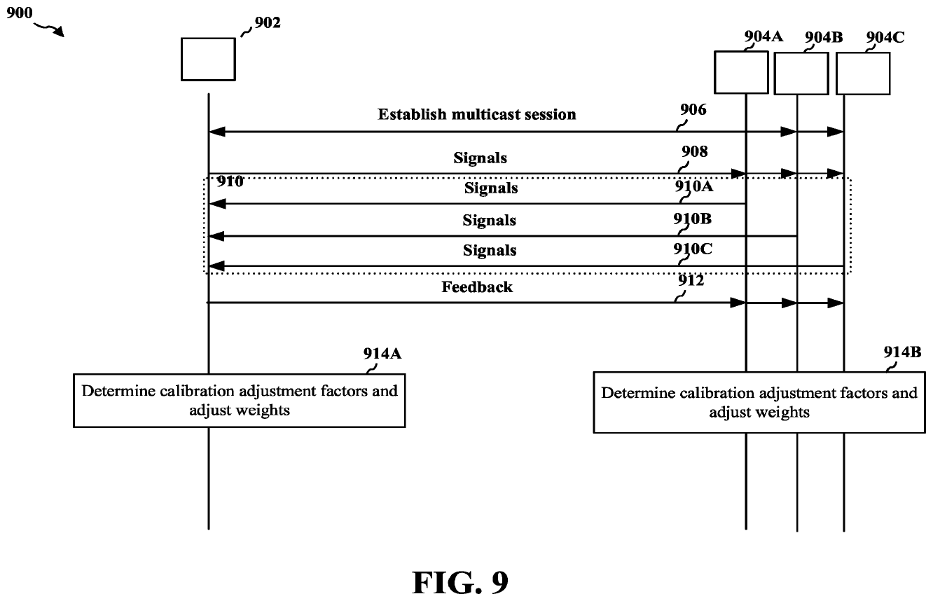

FIG. 9 is a diagram 900 illustrating example communications between wireless devices. As illustrated in FIG. 9, the wireless device 902 may establish a multicast session 906 with a group of wireless devices including the wireless device 904A, the wireless device 904B, and the wireless device 904C. In some aspects, the wireless device 902 may be a UE, a base station, a network node, a network entity, or the like. In some aspects, each wireless device of the group of wireless devices including the wireless device 904A, the wireless device 904B, and the wireless device 904C may be a UE, a base station, a network node, a network entity, or the like. In some aspects, the wireless device 902 may establish a multicast session 906 with each wireless device of the group of wireless devices including the wireless device 904A, the wireless device 904B, and the wireless device 904C based on configuration from a network entity. In some aspects, the wireless device 902 may establish a multicast session 906 with each wireless device of the group of wireless devices including the wireless device 904A, the wireless device 904B, and the wireless device 904C based on communications between the wireless device 902 each wireless device of the group of wireless devices including the wireless device 904A, the wireless device 904B, and the wireless device 904C, and independent of a network entity.

After establishing the multicast session 906, the wireless device 902 may transmit a set of signals 908, which may be CSI-RSs, SRSs, or other signals, to each wireless device of the group of wireless devices including the wireless device 904A, the wireless device 904B, and the wireless device 904C. Upon receiving the set of signals 908, each wireless device of the group of wireless devices including the wireless device 904A, the wireless device 904B, and the wireless device 904C may transmit a set of signals 910, which may be CSI-RSs, SRSs, or other signals, to the wireless device 902. In some aspects, the total number of signals in either the set of signals 908 or the set of signals 910, which may include signals 910A, signals 910B, and signals 910C may be equal to 2 times K times N squared, where N be a positive integer indicative of the total quantity of antenna elements at each wireless device of the group of wireless devices including the wireless device 904A, the wireless device 904B, and the wireless device 904C and K is a positive integer representing the total number of wireless devices in the group of wireless devices. In some aspects, signals from different wireless devices, such as the signals 910A, signals 910B, and signals 910C, may be processed by the first wireless device 902 using different sets of antenna elements (e.g., and different RF chains). In some aspects, to transmit the set of signals 908, each subset of signals in the set of signals that may be associated with respective wireless devices may be transmitted based on different sets of antenna elements (e.g., and different RF chains). Each of the antenna elements may be associated with a beam and all beams may be associated with a transmitted signal. In some aspects, upon receiving the set of signals 910, which may include signals 910A, signals 910B, and signals 910C, the wireless device 902 may transmit feedback information 912, which may include complex scalars, along with the Tx weight used for transmitting the set of signals 908, to each of the wireless devices 904A, 904B, or 904C so that each of the wireless devices 904A. 904B, or 904C may determine calibration adjustment factors (e.g., to perform Rx-Tx circuit path mismatch rectification) and adjust weights accordingly at 914B. In some aspects, the wireless device 902 may determine calibration adjustment factors (e.g., to perform Rx-Tx circuit path mismatch rectification) and adjust weights accordingly at 914A based on the set of signals 908 and the set of signals 910.

In some aspects, each of the wireless devices 904A, 904B, or 904C may use its own respective configured weights (e.g., beamforming vectors) for its respective set of signals 910A, 910B, or 910C. In some aspects, if N₁ denotes the quantity of antenna elements at the first wireless device 902, and N₂, . . . , N_{K} respectively denote the quantity of antenna elements at each of the wireless devices 904A, 904B, or 904C, and there may be a total of P sets of elements (and associated RF chains) at the first wireless device 902. For the set of signals 908, there may be N₁*max(N₂, . . . , N_{K}) measurements. For the set of signals 910, there may be

$$\frac{{N}_{1} {\sum }_{i = 2}^{K} {N}_{i}}{P}$$

measurements. In some aspects, the wireless device 902 may establish the multicast session 906 with each of the wireless devices 904A, 904B, or 904C based on communications between the wireless device 802 and each of the wireless devices 904A, 904B, or 904C independent of a network entity, based on signaling from a network entity, or based on pair-wise link budget across the wireless devices. In some aspects, the signal 908 may be scheduled based on communications between the wireless device 802 and each of the wireless devices 904A, 904B, or 904C independent of a network entity or based on signaling from a network entity.

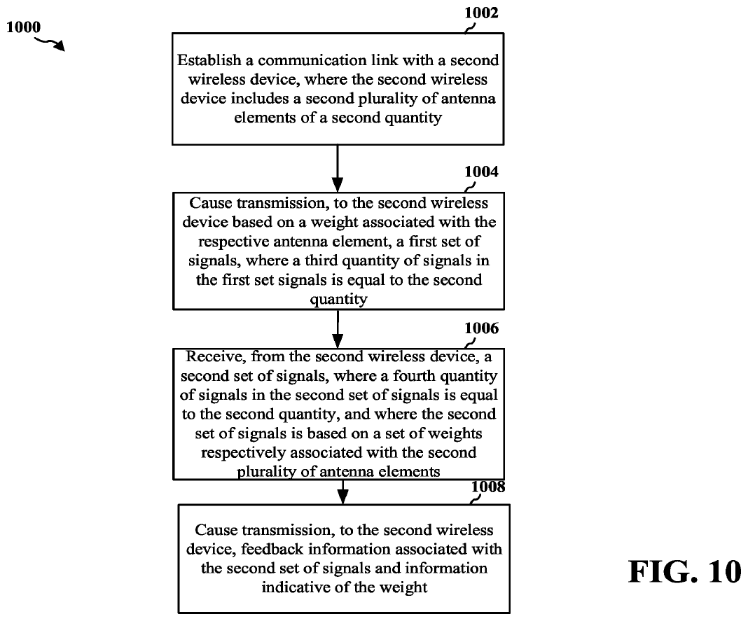

In some aspects, the communications illustrated in FIG. 8, FIG. 9, and FIG. 10 may be combined. For example, any of the wireless devices 904A, 9048, or 904C may perform procedures similar to the wireless device 702, the wireless device 802, or the wireless device 804N.

FIG. 10 is a flowchart 1000 of a method of wireless communication. The method may be performed by a first wireless device (e.g., the UE 104, the base station 102, the apparatus 1404, the network entity 1402, the apparatus 1502, the network entity 1660). The first wireless device may include a first plurality of antenna elements of a first quantity.

At 1002, the first wireless device may establish a communication link with a second wireless device, where the second wireless device includes a second plurality of antenna elements of a second quantity. For example, the wireless device (e.g., 702 or 802) may establish a communication link (e.g., 706 or 806) with a second wireless device (e.g., 704 or 804), where the second wireless device includes a second plurality of antenna elements of a second quantity. In some aspects, 1002 may be performed by calibration component 198.

For each respective antenna element of the first plurality of antenna elements, at 1004, the first wireless device may cause transmission, to the second wireless device based on a weight associated with the respective antenna element, a first set of signals, where a third quantity of signals in the first set of signals is equal to the second quantity. For example, the wireless device (e.g., 702 or 802) may cause transmission, to the second wireless device based on a weight associated with the respective antenna element, a first set of signals (e.g., 708 or 808), where a third quantity of signals in the first set of signals is equal to the second quantity. In some aspects, 1004 may be performed by calibration component 198.

For each respective antenna element of the first plurality of antenna elements, at 1006, the first wireless device may receive, from the second wireless device, a second set of signals, where a fourth quantity of signals in the second set of signals is equal to the second quantity, and where the second set of signals is based on a set of weights respectively associated with the second plurality of antenna elements. For example, the wireless device (e.g., 702 or 802) may receive, from the second wireless device, a second set of signals (e.g., 710 or 810), where a fourth quantity of signals in the second set of signals is equal to the second quantity, and where the second set of signals is based on a set of weights respectively associated with the second plurality of antenna elements. In some aspects, 1006 may be performed by calibration component 198.

For each respective antenna element of the first plurality of antenna elements, at 1008, the first wireless device may cause transmission, to the second wireless device, feedback information associated with the second set of signals and information indicative of the weight. For example, the wireless device (e.g., 702 or 802) may cause transmission, to the second wireless device, feedback information (e.g., 712 or 812) associated with the second set of signals and information indicative of the weight. In some aspects, 1008 may be performed by calibration component 198. In some aspects, the first wireless device may determine, based on the second set of signals and the information indicative of the weight, a set of calibration adjustment parameters associated with the first plurality of antenna elements. For example, the wireless device may determine (e.g., at 714A or 814A), based on the second set of signals and the information indicative of the weight, a set of calibration adjustment parameters associated with the first plurality of antenna elements. In some aspects, the first wireless device may adjust, based on the set of calibration adjustment parameters, the set of weights. For example, the wireless device may adjust (e.g., at 714A or 814A), based on the set of calibration adjustment parameters, the set of weights. In some aspects, the first set of signals is a set of CSI-RS or a first set of SRS, and where the second set of signals is a second set of SRS. In some aspects, the feedback information is associated with a set of complex scalars, where each complex scalar of the set of complex scalars is based on a first beamforming vector associated with the respective antenna element of the first plurality of antenna elements, a channel associated with the communication link, and a second beamforming vector associated with a respective antenna element of the second plurality of antenna elements. In some aspects, the first wireless device is a first network entity or a first UE, and where the second wireless device is a second network entity or a second UE.

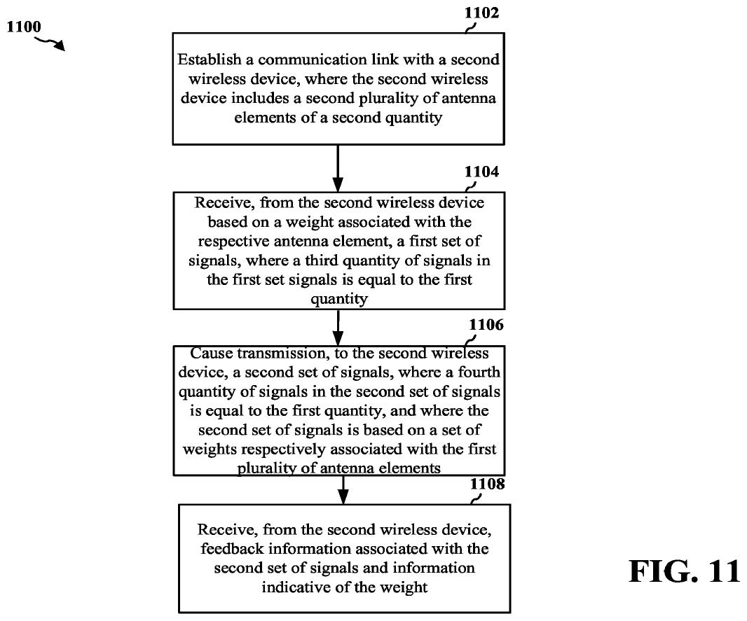

FIG. 11 is a flowchart 1100 of a method of wireless communication. The method may be performed by a first wireless device (e.g., the UE 104, the base station 102, the apparatus 1404, the network entity 1402, the apparatus 1502, the network entity 1660). The first wireless device may include a first plurality of antenna elements of a first quantity.

At 1102, the first wireless device may establish a communication link with a second wireless device, where the second wireless device includes a second plurality of antenna elements of a second quantity. For example, the wireless device (e.g., 704 or 804) may establish a communication link (e.g., 706 or 806) with a second wireless device (e.g., 702 or 802), where the second wireless device includes a second plurality of antenna elements of a second quantity. In some aspects, 1102 may be performed by calibration component 198.

For each respective antenna element of the second plurality of antenna elements, at 1104, the first wireless device may receive, from the second wireless device based on a weight associated with the respective antenna element, a first set of signals, where a third quantity of signals in the first set of signals is equal to the first quantity. For example, the wireless device (e.g., 704 or 804) may receive, from the second wireless device based on a weight associated with the respective antenna element, a first set of signals (e.g., 708 or 808), where a third quantity of signals in the first set of signals is equal to the first quantity. In some aspects, 1104 may be performed by calibration component 198.

For each respective antenna element of the second plurality of antenna elements, at 1106, the first wireless device may cause transmission, to the second wireless device, a second set of signals, where a fourth quantity of signals in the second set of signals is equal to the first quantity, and where the second set of signals is based on a set of weights respectively associated with the first plurality of antenna elements. For example, the wireless device (e.g., 704 or 804) may cause transmission, to the second wireless device, a second set of signals (e.g., 710 or 810), where a fourth quantity of signals in the second set of signals is equal to the first quantity, and where the second set of signals is based on a set of weights respectively associated with the first plurality of antenna elements. In some aspects, 1106 may be performed by calibration component 198.

For each respective antenna element of the second plurality of antenna elements, at 1108, the first wireless device may receive, from the second wireless device, feedback information associated with the second set of signals and information indicative of the weight. For example, the wireless device (e.g., 704 or 804) may receive, from the second wireless device (e.g., 712 or 812), feedback information associated with the second set of signals and information indicative of the weight. In some aspects, 1108 may be performed by calibration component 198. In some aspects, the first wireless device may determine, based on the second set of signals and the information indicative of the weight, a set of calibration adjustment parameters associated with the first plurality of antenna elements. For example, the wireless device may determine (e.g., at 714B or 814B), based on the second set of signals and the information indicative of the weight, a set of calibration adjustment parameters associated with the first plurality of antenna elements. In some aspects, the first wireless device may adjust, based on the set of calibration adjustment parameters, the set of weights. For example, the wireless device may adjust (e.g., at 714B or 814B), based on the set of calibration adjustment parameters, the set of weights. In some aspects, the first set of signals is a set of CSI-RS or a first set of SRS, and where the second set of signals is a second set of SRS. In some aspects, the feedback information is associated with a set of complex scalars, where each complex scalar of the set of complex scalars is based on a first beamforming vector associated with the respective antenna element of the first plurality of antenna elements, a channel associated with the communication link, and a second beamforming vector associated with a respective antenna element of the second plurality of antenna elements. In some aspects, the first wireless device is a first network entity or a first UE, and where the second wireless device is a second network entity or a second UE.

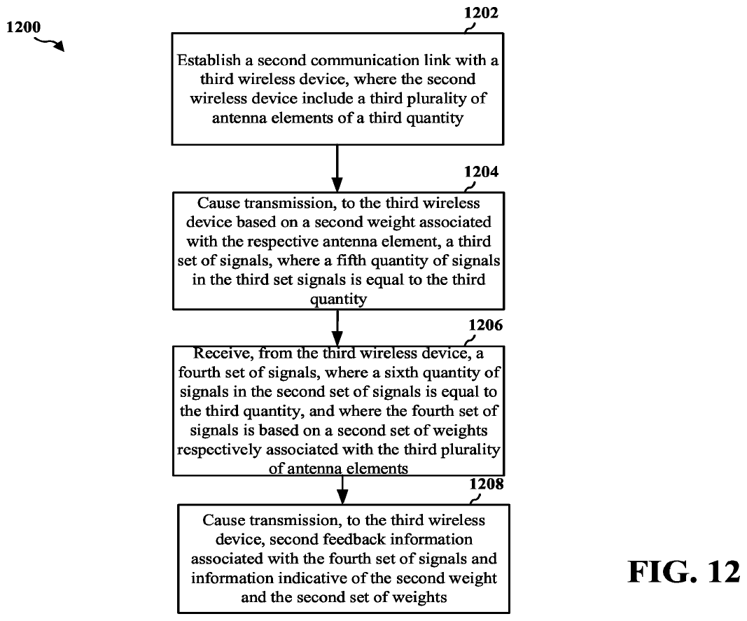

FIG. 12 is a flowchart 1200 of a method of wireless communication. The method may be performed by a first wireless device (e.g., the UE 104, the base station 102, the apparatus 1404, the network entity 1402, the apparatus 1502, the network entity 1660). The first wireless device may include a first plurality of antenna elements of a first quantity.

At 1202, the first wireless device may establish a second communication link with a third wireless device, where the third wireless device includes a third plurality of antenna elements of a third quantity. For example, the wireless device (e.g., 702, 704, 802, or 804) may establish a second communication link (e.g., 826) with a third wireless device (e.g., 804N), where the third wireless device includes a third plurality of antenna elements of a third quantity. In some aspects, 1202 may be performed by calibration component 198.

For each respective antenna element of the first plurality of antenna elements, at 1204, the first wireless device may cause transmission, to the third wireless device based on a second weight associated with the respective antenna element, a third set of signals (e.g., 828), where a fifth quantity of signals in the third set of signals is equal to the third quantity. For example, the wireless device (e.g., 702, 704, 802, or 804) may cause transmission, to the third wireless device (e.g., 804N) based on a second weight associated with the respective antenna element, a third set of signals, where a fifth quantity of signals in the third set of signals is equal to the third quantity. In some aspects, 1204 may be performed by calibration component 198.

For each respective antenna element of the first plurality of antenna elements, at 1206, the first wireless device may receive, from the third wireless device, a fourth set of signals, where a sixth quantity of signals in the second set of signals is equal to the third quantity, and where the fourth set of signals is based on a second set of weights respectively associated with the third plurality of antenna elements. For example, the wireless device (e.g., 702, 704, 802, or 804) may receive, from the third wireless device (e.g., 804N), a fourth set of signals (e.g., 830), where a sixth quantity of signals in the second set of signals is equal to the third quantity, and where the fourth set of signals is based on a second set of weights respectively associated with the third plurality of antenna elements. In some aspects, 1206 may be performed by calibration component 198.

For each respective antenna element of the first plurality of antenna elements, at 1208, the first wireless device may cause transmission, to the third wireless device, second feedback information associated with the fourth set of signals and information indicative of the second weight and the second set of weights. For example, the wireless device (e.g., 702, 704, 802, or 804) may cause transmission, to the third wireless device (e.g., 804N), second feedback information (e.g., 832) associated with the fourth set of signals and information indicative of the second weight and the second set of weights. In some aspects, 1208 may be performed by calibration component 198. In some aspects, the third set of signals is a third set of SRS, and where the fourth set of signals is a fourth set of SRS. In some aspects, the first communication link or the second communication link is based on a configuration from a network entity. In some aspects, the first communication link or the second communication link is independent of a configuration from a network entity.

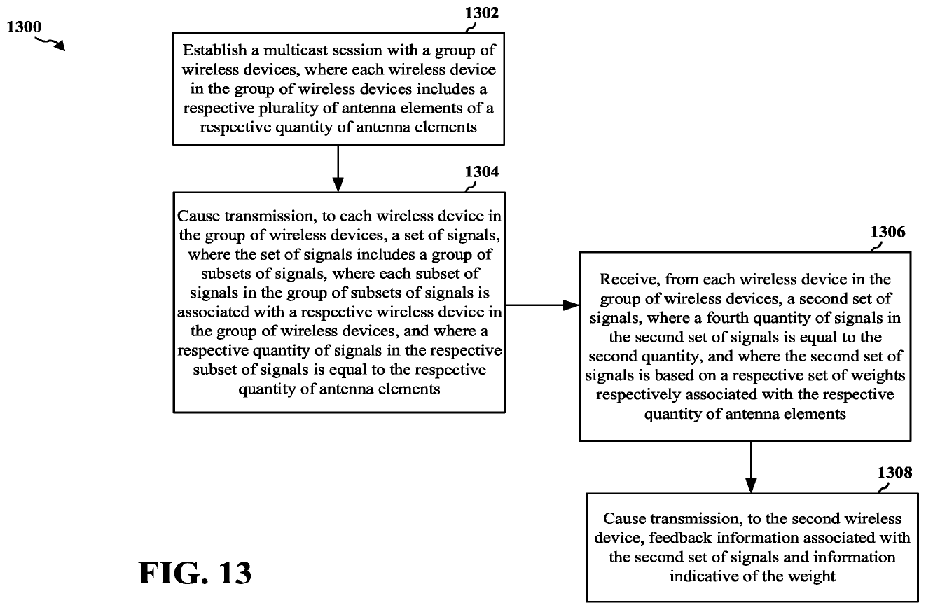

FIG. 13 is a flowchart 1300 of a method of wireless communication. The method may be performed by a first wireless device (e.g., the UE 104, the base station 102, the apparatus 1404, the wireless device 902, the network entity 1402, the apparatus 1502, the network entity 1660). The first wireless device may include a first plurality of antenna elements of a first quantity.

At 1302, the first wireless device may establish a multicast session with a group of wireless devices, where each wireless device in the group of wireless devices includes a respective plurality of antenna elements of a respective quantity of antenna elements. For example, the wireless device 902 may establish a multicast session (e.g., 906) with a group of wireless devices (e.g., 904A, 904B, or 904C), where each wireless device in the group of wireless devices includes a respective plurality of antenna elements of a respective quantity of antenna elements. In some aspects, 1302 may be performed by calibration component 198.

At 1304, the first wireless device may cause transmission, to each wireless device in the group of wireless devices, a set of signals, where the set of signals includes a group of subsets of signals, where each subset of signals in the group of subsets of signals is associated with a respective wireless device in the group of wireless devices, and where a respective quantity of signals in the respective subset of signals is equal to the respective quantity of antenna elements. For example, the wireless device 902 may cause transmission, to each wireless device (e.g., 904A, 904B, or 904C) in the group of wireless devices, a set of signals (e.g., 908), where the set of signals includes a group of subsets of signals, where each subset of signals in the group of subsets of signals is associated with a respective wireless device in the group of wireless devices, and where a respective quantity of signals in the respective subset of signals is equal to the respective quantity of antenna elements. In some aspects, 1304 may be performed by calibration component 198.

At 1306, the first wireless device may receive, from each wireless device in the group of wireless devices, a second set of signals, where a fourth quantity of signals in the second set of signals is equal to the second quantity, and where the second set of signals is based on a respective set of weights respectively associated with the respective quantity of antenna elements. For example, the wireless device 902 may receive, from each wireless device (e.g., 904A, 904B, or 904C) in the group of wireless devices, a second set of signals (e.g., 910A, 910B, or 910C), where a fourth quantity of signals in the second set of signals is equal to the second quantity, and where the second set of signals is based on a respective set of weights respectively associated with the respective quantity of antenna elements. In some aspects, 1306 may be performed by calibration component 198.

At 1308, the first wireless device may cause transmission, to the second wireless device, feedback information (e.g., 912) associated with the second set of signals and information indicative of the weight. For example, the wireless device 902 may cause transmission, to the second wireless device, feedback information associated with the second set of signals and information indicative of the weight. In some aspects, 1308 may be performed by calibration component 198. In some aspects, the wireless device may determine, based on the second set of signals and the information indicative of the weight, a set of calibration adjustment parameters associated with the first plurality of antenna elements and adjust, based on the set of calibration adjustment parameters, the set of weights (e.g., at 914A). In some aspects, the first set of signals is a set of CSI-RS or a first set of SRS, and where the second set of signals is a second set of SRS. In some aspects, the feedback information is associated with a set of complex scalars, where each complex scalar of the set of complex scalars is based on a first beamforming vector associated with the respective antenna element of the first plurality of antenna elements, a channel associated with the communication link, and a second beamforming vector associated with a respective antenna element of the second plurality of antenna elements. In some aspects, the first wireless device is a first network entity or a first UE, and where each wireless device in the group of wireless devices is a second network entity or a second UE.

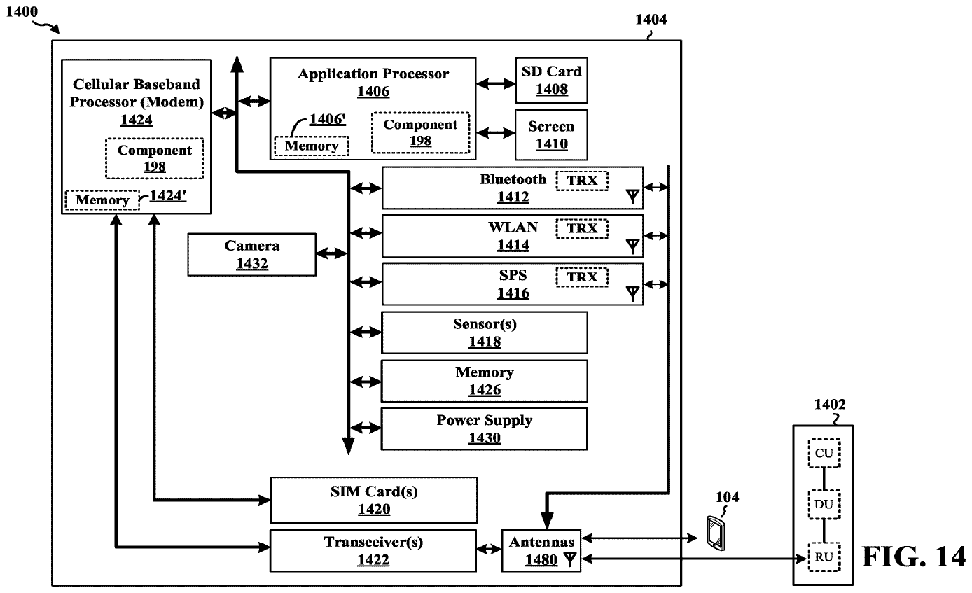

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include a cellular baseband processor 1424 (also referred to as a modem) coupled to one or more transceivers 1422 (e.g., cellular RF transceiver). The cellular baseband processor 1424 may include on-chip memory 1424′. In some aspects, the apparatus 1404 may further include one or more subscriber identity modules (SIM) cards 1420 and an application processor 1406 coupled to a secure digital (SD) card 1408 and a screen 1410. The application processor 1406 may include on-chip memory 1406′. In some aspects, the apparatus 1404 may further include a Bluetooth module 1412, a WLAN module 1414, a satellite system module 1416 (e.g., GNSS module), one or more sensor modules 1418 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the satellite system module 1416 may include an on-chip transceiver (TRX)/receiver (RX). The cellular baseband processor 1424 communicates through the transceiver(s) 1422 via one or more antennas 1480 with the UE 104 and/or with an RU associated with a network entity 1402. The cellular baseband processor 1424 and the application processor 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor 1424 and the application processor 1406 are each responsible for general processing, including the execution of software stored on the computer-readable medium/memory. The software, when executed by the cellular baseband processor 1424/application processor 1406, causes the cellular baseband processor 1424/application processor 1406 to perform the various functions described herein. The computer-readable medium/memory may also be used for storing data that is manipulated by the cellular baseband processor 1424/application processor 1406 when executing software. The cellular baseband processor 1424/application processor 1406 may be a component of the UE 350 and may include the memory 360 and/or at least one of the TX processor 368, the RX processor 356, and the controller/processor 359. In one configuration, the apparatus 1404 may be a processor chip (modem and/or application) and include just the cellular baseband processor 1424 and/or the application processor 1406, and in another configuration, the apparatus 1404 may be the entire UE (e.g., see 350 of FIG. 3) and include the additional modules of the apparatus 1404.

As discussed herein, the calibration component 198 may be configured to establish a communication link with a second wireless device, where the second wireless device includes a second plurality of antenna elements of a second quantity. The calibration component 198 may be configured to, for each respective antenna element of the first plurality of antenna elements: cause transmission, to the second wireless device based on a weight associated with the respective antenna element, a first set of signals, where a third quantity of signals in the first set of signals is equal to the second quantity, receive, from the second wireless device, a second set of signals, where a fourth quantity of signals in the second set of signals is equal to the second quantity, and where the second set of signals is based on a set of weights respectively associated with the second plurality of antenna elements, and cause transmission, to the second wireless device, feedback information associated with the second set of signals and information indicative of the weight. The calibration component 198 may be configured to establish a communication link with a second wireless device, where the second wireless device includes a second plurality of antenna elements of a second quantity. The calibration component 198 may be configured to for each respective antenna element of the second plurality of antenna elements: receive, from the second wireless device based on a weight associated with the respective antenna element, a first set of signals, where a third quantity of signals in the first set of signals is equal to the first quantity, cause transmission, to the second wireless device, a second set of signals, where a fourth quantity of signals in the second set of signals is equal to the first quantity, and where the second set of signals is based on a set of weights respectively associated with the first plurality of antenna elements, and receive, from the second wireless device, feedback information associated with the second set of signals and information indicative of the weight. The calibration component 198 may be configured to establish a multicast session with a group of wireless devices, where each wireless device in the group of wireless devices includes a respective plurality of antenna elements of a respective quantity of antenna elements. The calibration component 198 may be configured to cause transmission, to each wireless device in the group of wireless devices, a set of signals, where the set of signals includes a group of subsets of signals, where each subset of signals in the group of subsets of signals is associated with a respective wireless device in the group of wireless devices, and where a respective quantity of signals in the respective subset of signals is equal to the respective quantity of antenna elements. The calibration component 198 may be configured to receive, from each wireless device in the group of wireless devices, a second set of signals, where a fourth quantity of signals in the second set of signals is equal to the second quantity, and where the second set of signals is based on a respective set of weights respectively associated with the respective quantity of antenna elements. The calibration component 198 may be configured to cause transmission, to the second wireless device, feedback information associated with the second set of signals and information indicative of the weight. The calibration component 198 may be within the cellular baseband processor 1424, the application processor 1406, or both the cellular baseband processor 1424 and the application processor 1406. The calibration component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1404 may include a variety of components configured for various functions. The apparatus 1404 may include a first plurality of antenna elements of a first quantity, a memory, and calibration component 198 coupled to the memory. The apparatus 1404 may include means for establishing a communication link with a second wireless device, where the second wireless device includes a second plurality of antenna elements of a second quantity. The apparatus 1404 may include, for each respective antenna element of the first plurality of antenna elements, means for causing transmission, to the second wireless device based on a weight associated with the respective antenna element, a first set of signals, where a third quantity of signals in the first set of signals is equal to the second quantity, receiving, from the second wireless device, a second set of signals, where a fourth quantity of signals in the second set of signals is equal to the second quantity, and where the second set of signals is based on a set of weights respectively associated with the second plurality of antenna elements, and causing transmission, to the second wireless device, feedback information associated with the second set of signals and information indicative of the weight. The apparatus 1404 may include means for establishing a communication link with a second wireless device, where the second wireless device includes a second plurality of antenna elements of a second quantity. The apparatus 1404 may include, for each respective antenna element of the second plurality of antenna elements, means for receiving, from the second wireless device based on a weight associated with the respective antenna element, a first set of signals, where a third quantity of signals in the first set of signals is equal to the first quantity, causing transmission, to the second wireless device, a second set of signals, where a fourth quantity of signals in the second set of signals is equal to the first quantity, and where the second set of signals is based on a set of weights respectively associated with the first plurality of antenna elements, and receiving, from the second wireless device, feedback information associated with the second set of signals and information indicative of the weight. The apparatus 1404 may include means for establishing a multicast session with a group of wireless devices, where each wireless device in the group of wireless devices includes a respective plurality of antenna elements of a respective quantity of antenna elements. The apparatus 1404 may include means for causing transmission, to each wireless device in the group of wireless devices, a set of signals, where the set of signals includes a group of subsets of signals, where each subset of signals in the group of subsets of signals is associated with a respective wireless device in the group of wireless devices, and where a respective quantity of signals in the respective subset of signals is equal to the respective quantity of antenna elements. The apparatus 1404 may include means for receiving, from each wireless device in the group of wireless devices, a second set of signals, where a fourth quantity of signals in the second set of signals is equal to the second quantity, and where the second set of signals is based on a respective set of weights respectively associated with the respective quantity of antenna elements. The apparatus 1404 may include means for causing transmission, to the second wireless device, feedback information associated with the second set of signals and information indicative of the weight. The apparatus 1404 may include means for determining, based on the second set of signals and the information indicative of the weight, a set of calibration adjustment parameters associated with the first plurality of antenna elements. The apparatus 1404 may include means for adjusting, based on the set of calibration adjustment parameters, the set of weights. The apparatus 1404 may include means for establishing a second communication link with a third wireless device, where the third wireless device includes a third plurality of antenna elements of a third quantity. The apparatus 1404 may include, for each respective antenna element of the first plurality of antenna elements, means for causing transmission, to the third wireless device based on a second weight associated with the respective antenna element, a third set of signals, where a fifth quantity of signals in the third set of signals is equal to the third quantity, receiving, from the third wireless device, a fourth set of signals, where a sixth quantity of signals in the second set of signals is equal to the third quantity, and where the fourth set of signals is based on a second set of weights respectively associated with the third plurality of antenna elements, and causing transmission, to the third wireless device, second feedback information associated with the fourth set of signals and information indicative of the second weight and the second set of weights. The means may be the calibration component 198 of the apparatus 1404 configured to perform the functions recited by the means. As described herein, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

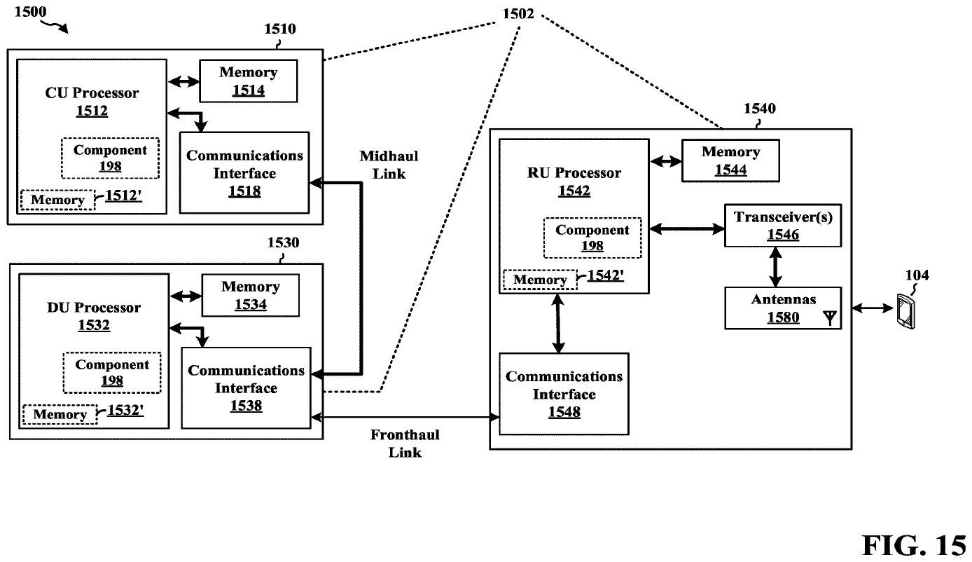

FIG. 15 is a diagram 1500 illustrating an example of a hardware implementation for an apparatus 1502. The apparatus 1502 may be a BS, a component of a BS, or may implement BS functionality. The apparatus 1502 may include at least one of a CU 1510, a DU 1530, or an RU 1540. For example, depending on the layer functionality handled by the component 198, the apparatus 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include a CU processor 1512. The CU processor 1512 may include on-chip memory 1512′. In some aspects, the CU 1510 may further include additional memory modules 1514 and a communications interface 1518. The CU 1510 communicates with the DU 1530 through a midhaul link, such as an F1 interface. The DU 1530 may include a DU processor 1532. The DU processor 1532 may include on-chip memory 1532′. In some aspects, the DU 1530 may further include additional memory modules 1534 and a communications interface 1538. The DU 1530 communicates with the RU 1540 through a fronthaul link. The RU 1540 may include an RU processor 1542. The RU processor 1542 may include on-chip memory 1542′. In some aspects, the RU 1540 may further include additional memory modules 1544, one or more transceivers 1546, antennas 1580, and a communications interface 1548. The RU 1540 communicates with the UE 104. The on-chip memory 1512′, 1532′, 1542′ and the additional memory modules 1514, 1534, 1544 may each be considered a computer-readable medium/memory. Each computer-readable medium/memory may be non-transitory. Each of the processors 1512, 1532, 1542 is responsible for general processing, including the execution of software stored on the computer-readable medium/memory. The software, when executed by the corresponding processor(s) causes the processor(s) to perform the various functions described herein. The computer-readable medium/memory may also be used for storing data that is manipulated by the processor(s) when executing software.

As discussed herein, the calibration component 198 may be configured to establish a communication link with a second wireless device, where the second wireless device includes a second plurality of antenna elements of a second quantity. The calibration component 198 may be configured to, for each respective antenna element of the first plurality of antenna elements: cause transmission, to the second wireless device based on a weight associated with the respective antenna element, a first set of signals, where a third quantity of signals in the first set of signals is equal to the second quantity, receive, from the second wireless device, a second set of signals, where a fourth quantity of signals in the second set of signals is equal to the second quantity, and where the second set of signals is based on a set of weights respectively associated with the second plurality of antenna elements, and cause transmission, to the second wireless device, feedback information associated with the second set of signals and information indicative of the weight. The calibration component 198 may be configured to establish a communication link with a second wireless device, where the second wireless device includes a second plurality of antenna elements of a second quantity. The calibration component 198 may be configured to for each respective antenna element of the second plurality of antenna elements: receive, from the second wireless device based on a weight associated with the respective antenna element, a first set of signals, where a third quantity of signals in the first set of signals is equal to the first quantity, cause transmission, to the second wireless device, a second set of signals, where a fourth quantity of signals in the second set of signals is equal to the first quantity, and where the second set of signals is based on a set of weights respectively associated with the first plurality of antenna elements, and receive, from the second wireless device, feedback information associated with the second set of signals and information indicative of the weight. The calibration component 198 may be configured to establish a multicast session with a group of wireless devices, where each wireless device in the group of wireless devices includes a respective plurality of antenna elements of a respective quantity of antenna elements. The calibration component 198 may be configured to cause transmission, to each wireless device in the group of wireless devices, a set of signals, where the set of signals includes a group of subsets of signals, where each subset of signals in the group of subsets of signals is associated with a respective wireless device in the group of wireless devices, and where a respective quantity of signals in the respective subset of signals is equal to the respective quantity of antenna elements. The calibration component 198 may be configured to receive, from each wireless device in the group of wireless devices, a second set of signals, where a fourth quantity of signals in the second set of signals is equal to the second quantity, and where the second set of signals is based on a respective set of weights respectively associated with the respective quantity of antenna elements. The calibration component 198 may be configured to cause transmission, to the second wireless device, feedback information associated with the second set of signals and information indicative of the weight. The calibration component 198 may be within one or more processors of one or more of the CU 1510, DU 1530, and the RU 1540. The calibration component 198 may be one or more hardware components specifically configured to carry out the stated processes/algorithm, implemented by one or more processors configured to perform the stated processes/algorithm, stored within a computer-readable medium for implementation by one or more processors, or some combination thereof. The apparatus 1502 may include a variety of components configured for various functions. The apparatus 1502 may include a first plurality of antenna elements of a first quantity, a memory, and calibration component 198 coupled to the memory. The apparatus 1502 may include means for establishing a communication link with a second wireless device, where the second wireless device includes a second plurality of antenna elements of a second quantity. The apparatus 1502 may include, for each respective antenna element of the first plurality of antenna elements, means for causing transmission, to the second wireless device based on a weight associated with the respective antenna element, a first set of signals, where a third quantity of signals in the first set of signals is equal to the second quantity, receiving, from the second wireless device, a second set of signals, where a fourth quantity of signals in the second set of signals is equal to the second quantity, and where the second set of signals is based on a set of weights respectively associated with the second plurality of antenna elements, and causing transmission, to the second wireless device, feedback information associated with the second set of signals and information indicative of the weight. The apparatus 1502 may include means for establishing a communication link with a second wireless device, where the second wireless device includes a second plurality of antenna elements of a second quantity. The apparatus 1502 may include, for each respective antenna element of the second plurality of antenna elements, means for receiving, from the second wireless device based on a weight associated with the respective antenna element, a first set of signals, where a third quantity of signals in the first set of signals is equal to the first quantity, causing transmission, to the second wireless device, a second set of signals, where a fourth quantity of signals in the second set of signals is equal to the first quantity, and where the second set of signals is based on a set of weights respectively associated with the first plurality of antenna elements, and receiving, from the second wireless device, feedback information associated with the second set of signals and information indicative of the weight. The apparatus 1502 may include means for establishing a multicast session with a group of wireless devices, where each wireless device in the group of wireless devices includes a respective plurality of antenna elements of a respective quantity of antenna elements. The apparatus 1502 may include means for causing transmission, to each wireless device in the group of wireless devices, a set of signals, where the set of signals includes a group of subsets of signals, where each subset of signals in the group of subsets of signals is associated with a respective wireless device in the group of wireless devices, and where a respective quantity of signals in the respective subset of signals is equal to the respective quantity of antenna elements. The apparatus 1502 may include means for receiving, from each wireless device in the group of wireless devices, a second set of signals, where a fourth quantity of signals in the second set of signals is equal to the second quantity, and where the second set of signals is based on a respective set of weights respectively associated with the respective quantity of antenna elements. The apparatus 1502 may include means for causing transmission, to the second wireless device, feedback information associated with the second set of signals and information indicative of the weight. The apparatus 1502 may include means for determining, based on the second set of signals and the information indicative of the weight, a set of calibration adjustment parameters associated with the first plurality of antenna elements. The apparatus 1502 may include means for adjusting, based on the set of calibration adjustment parameters, the set of weights. The apparatus 1502 may include means for establishing a second communication link with a third wireless device, where the third wireless device includes a third plurality of antenna elements of a third quantity. The apparatus 1502 may include, for each respective antenna element of the first plurality of antenna elements, means for causing transmission, to the third wireless device based on a second weight associated with the respective antenna element, a third set of signals, where a fifth quantity of signals in the third set of signals is equal to the third quantity, receiving, from the third wireless device, a fourth set of signals, where a sixth quantity of signals in the second set of signals is equal to the third quantity, and where the fourth set of signals is based on a second set of weights respectively associated with the third plurality of antenna elements, and causing transmission, to the third wireless device, second feedback information associated with the fourth set of signals and information indicative of the second weight and the second set of weights. The means may be the calibration component 198 of the apparatus 1502 configured to perform the functions recited by the means. As described herein, the apparatus 1502 may include the TX processor 316, the RX processor 370, and the controller/processor 375. As such, in one configuration, the means may be the TX processor 316, the RX processor 370, and/or the controller/processor 375 configured to perform the functions recited by the means.

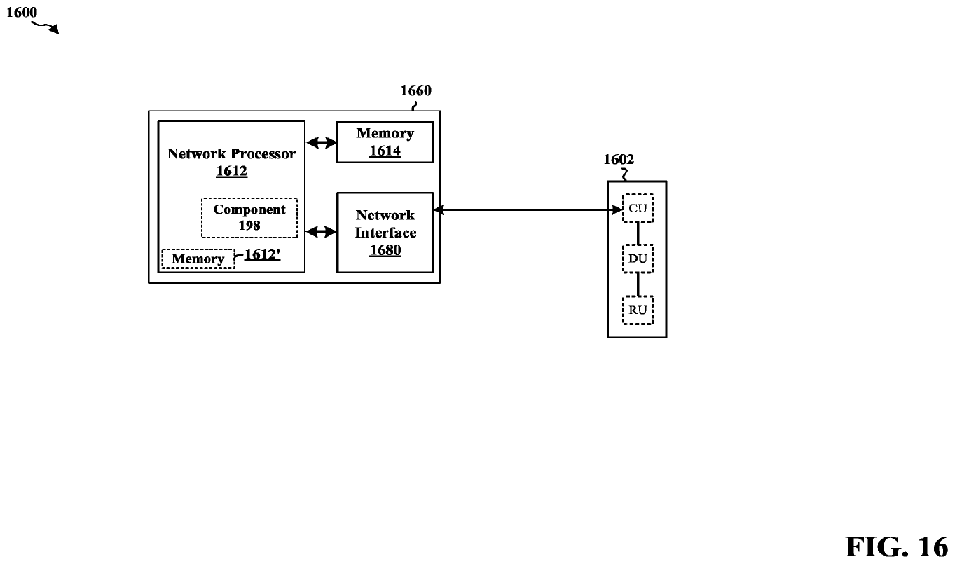

FIG. 16 is a diagram 1600 illustrating an example of a hardware implementation for a network entity 1660. In one example, the network entity 1660 may be within the core network 120. The network entity 1660 may include a network processor 1612. The network processor 1612 may include on-chip memory 1612′. In some aspects, the network entity 1660 may further include additional memory modules 1614. The network entity 1660 communicates via the network interface 1680 directly (e.g., backhaul link) or indirectly (e.g., through a RIC) with the CU 1602. The on-chip memory 1612′ and the additional memory modules 1614 may each be considered a computer-readable medium/memory. Each computer-readable medium/memory may be non-transitory. The processor 1612 is responsible for general processing, including the execution of software stored on the computer-readable medium/memory. The software, when executed by the corresponding processor(s) causes the processor(s) to perform the various functions described herein. The computer-readable medium/memory may also be used for storing data that is manipulated by the processor(s) when executing software.

As discussed herein, the calibration component 198 may be configured to establish a communication link with a second wireless device, where the second wireless device includes a second plurality of antenna elements of a second quantity. The calibration component 198 may be configured to, for each respective antenna element of the first plurality of antenna elements: cause transmission, to the second wireless device based on a weight associated with the respective antenna element, a first set of signals, where a third quantity of signals in the first set of signals is equal to the second quantity, receive, from the second wireless device, a second set of signals, where a fourth quantity of signals in the second set of signals is equal to the second quantity, and where the second set of signals is based on a set of weights respectively associated with the second plurality of antenna elements, and cause transmission, to the second wireless device, feedback information associated with the second set of signals and information indicative of the weight. The calibration component 198 may be configured to establish a communication link with a second wireless device, where the second wireless device includes a second plurality of antenna elements of a second quantity. The calibration component 198 may be configured to for each respective antenna element of the second plurality of antenna elements: receive, from the second wireless device based on a weight associated with the respective antenna element, a first set of signals, where a third quantity of signals in the first set of signals is equal to the first quantity, cause transmission, to the second wireless device, a second set of signals, where a fourth quantity of signals in the second set of signals is equal to the first quantity, and where the second set of signals is based on a set of weights respectively associated with the first plurality of antenna elements, and receive, from the second wireless device, feedback information associated with the second set of signals and information indicative of the weight. The calibration component 198 may be configured to establish a multicast session with a group of wireless devices, where each wireless device in the group of wireless devices includes a respective plurality of antenna elements of a respective quantity of antenna elements. The calibration component 198 may be configured to cause transmission, to each wireless device in the group of wireless devices, a set of signals, where the set of signals includes a group of subsets of signals, where each subset of signals in the group of subsets of signals is associated with a respective wireless device in the group of wireless devices, and where a respective quantity of signals in the respective subset of signals is equal to the respective quantity of antenna elements. The calibration component 198 may be configured to receive, from each wireless device in the group of wireless devices, a second set of signals, where a fourth quantity of signals in the second set of signals is equal to the second quantity, and where the second set of signals is based on a respective set of weights respectively associated with the respective quantity of antenna elements. The calibration component 198 may be configured to cause transmission, to the second wireless device, feedback information associated with the second set of signals and information indicative of the weight. The component 198 may be within the processor 1612. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1660 may include a variety of components configured for various functions. The network entity 1660 may include a first plurality of antenna elements of a first quantity, a memory, and calibration component 198 coupled to the memory. The network entity 1660 may include means for establishing a communication link with a second wireless device, where the second wireless device includes a second plurality of antenna elements of a second quantity. The network entity 1660 may include, for each respective antenna element of the first plurality of antenna elements, means for causing transmission, to the second wireless device based on a weight associated with the respective antenna element, a first set of signals, where a third quantity of signals in the first set of signals is equal to the second quantity, receiving, from the second wireless device, a second set of signals, where a fourth quantity of signals in the second set of signals is equal to the second quantity, and where the second set of signals is based on a set of weights respectively associated with the second plurality of antenna elements, and causing transmission, to the second wireless device, feedback information associated with the second set of signals and information indicative of the weight. The network entity 1660 may include means for establishing a communication link with a second wireless device, where the second wireless device includes a second plurality of antenna elements of a second quantity. The network entity 1660 may include, for each respective antenna element of the second plurality of antenna elements, means for receiving, from the second wireless device based on a weight associated with the respective antenna element, a first set of signals, where a third quantity of signals in the first set of signals is equal to the first quantity, causing transmission, to the second wireless device, a second set of signals, where a fourth quantity of signals in the second set of signals is equal to the first quantity, and where the second set of signals is based on a set of weights respectively associated with the first plurality of antenna elements, and receiving, from the second wireless device, feedback information associated with the second set of signals and information indicative of the weight. The network entity 1660 may include means for establishing a multicast session with a group of wireless devices, where each wireless device in the group of wireless devices includes a respective plurality of antenna elements of a respective quantity of antenna elements. The network entity 1660 may include means for causing transmission, to each wireless device in the group of wireless devices, a set of signals, where the set of signals includes a group of subsets of signals, where each subset of signals in the group of subsets of signals is associated with a respective wireless device in the group of wireless devices, and where a respective quantity of signals in the respective subset of signals is equal to the respective quantity of antenna elements. The network entity 1660 may include means for receiving, from each wireless device in the group of wireless devices, a second set of signals, where a fourth quantity of signals in the second set of signals is equal to the second quantity, and where the second set of signals is based on a respective set of weights respectively associated with the respective quantity of antenna elements. The network entity 1660 may include means for causing transmission, to the second wireless device, feedback information associated with the second set of signals and information indicative of the weight. The network entity 1660 may include means for determining, based on the second set of signals and the information indicative of the weight, a set of calibration adjustment parameters associated with the first plurality of antenna elements. The network entity 1660 may include means for adjusting, based on the set of calibration adjustment parameters, the set of weights. The network entity 1660 may include means for establishing a second communication link with a third wireless device, where the third wireless device includes a third plurality of antenna elements of a third quantity. The network entity 1660 may include, for each respective antenna element of the first plurality of antenna elements, means for causing transmission, to the third wireless device based on a second weight associated with the respective antenna element, a third set of signals, where a fifth quantity of signals in the third set of signals is equal to the third quantity, receiving, from the third wireless device, a fourth set of signals, where a sixth quantity of signals in the second set of signals is equal to the third quantity, and where the fourth set of signals is based on a second set of weights respectively associated with the third plurality of antenna elements, and causing transmission, to the third wireless device, second feedback information associated with the fourth set of signals and information indicative of the second weight and the second set of weights. The means may be the component 198 of the network entity 1660 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B. or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B. and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a first wireless device for wireless communication, including: a first plurality of antenna elements of a first quantity; a memory; and at least one processor coupled to the memory, where the at least one processor is configured to: establish a communication link with a second wireless device, where the second wireless device includes a second plurality of antenna elements of a second quantity; and for each respective antenna element of the first plurality of antenna elements: cause transmission, to the second wireless device based on a weight associated with the respective antenna element, of a first set of signals, where a third quantity of signals in the first set of signals is equal to the second quantity; receive, from the second wireless device, a second set of signals, where a fourth quantity of signals in the second set of signals is equal to the second quantity, and where the second set of signals is based on a set of weights respectively associated with the second plurality of antenna elements; and cause transmission, to the second wireless device, of feedback information associated with the second set of signals and information indicative of the weight.

Aspect 2 is the first wireless device of aspect 1, where the at least one processor is configured to: determine, based on the second set of signals and the information indicative of the weight, a set of calibration adjustment parameters associated with the first plurality of antenna elements; and adjust, based on the set of calibration adjustment parameters, the set of weights.

Aspect 3 is the first wireless device of any of aspects 1-2 where the first set of signals is a set of channel state information (CSI) reference signals (CSI-RSs) or a first set of sounding reference signals (SRSs), and where the second set of signals is a second set of SRS.

Aspect 4 is the first wireless device of any of aspects 1-3, where the feedback information is associated with a set of complex scalars, where each complex scalar of the set of complex scalars is based on a first beamforming vector associated with the respective antenna element of the first plurality of antenna elements, a channel associated with the communication link, and a second beamforming vector associated with a respective antenna element of the second plurality of antenna elements.

Aspect 5 is the first wireless device of any of aspects 1-4, where the first wireless device is a first network entity or a first user equipment (UE), and where the second wireless device is a second network entity or a second UE.

Aspect 6 is the first wireless device of any of aspects 1-5, where the at least one processor is configured to: establish a second communication link with a third wireless device, where the third wireless device includes a third plurality of antenna elements of a third quantity; and for each respective antenna element of the first plurality of antenna elements: cause transmission, to the third wireless device based on a second weight associated with the respective antenna element, of a third set of signals, where a fifth quantity of signals in the third set of signals is equal to the third quantity; receive, from the third wireless device, a fourth set of signals, where a sixth quantity of signals in the second set of signals is equal to the third quantity, and where the fourth set of signals is based on a second set of weights respectively associated with the third plurality of antenna elements; and cause transmission, to the third wireless device, of second feedback information associated with the fourth set of signals and information indicative of the second weight and the second set of weights.

Aspect 7 is the first wireless device of aspect 6, where the third set of signals is a third set of sounding reference signals (SRSs), and where the fourth set of signals is a fourth set of SRS.

Aspect 8 is the first wireless device of any of aspects 1-7, where the second feedback information is associated with a second set of complex scalars, where each complex scalar of the second set of complex scalars is based on a third beamforming vector associated with the respective antenna element of the first plurality of antenna elements, a channel associated with the second communication link, and a fourth beamforming vector associated with a respective antenna element of the third plurality of antenna elements.

Aspect 9 is the first wireless device of any of aspects 1-8, where the communication link or the second communication link is based on a configuration from a network entity.

Aspect 10 is the first wireless device of any of aspects 1-8, where the communication link or the second communication link is independent of a configuration from a network entity.

Aspect 11 is a first wireless device for wireless communication, including: a first plurality of antenna elements of a first quantity, where is respectively associated with a respective beam; a memory; and at least one processor coupled to the memory, where the at least one processor is configured to establish a communication link with a second wireless device, where the second wireless device includes a second plurality of antenna elements of a second quantity; and for each respective antenna element of the second plurality of antenna elements: receive, from the second wireless device based on a weight associated with the respective antenna element, a first set of signals, where a third quantity of signals in the first set of signals is equal to the first quantity; cause transmission, to the second wireless device, of a second set of signals, where a fourth quantity of signals in the second set of signals is equal to the first quantity, and where the second set of signals is based on a set of weights respectively associated with the first plurality of antenna elements; and receive, from the second wireless device, feedback information associated with the second set of signals and information indicative of the weight.

Aspect 12 is the first wireless device of aspect 11, where the at least one processor is configured to: determine, based on the feedback information and the information indicative of the weight, a set of calibration adjustment parameters associated with the first plurality of antenna elements; and adjust, based on the set of calibration adjustment parameters, the set of weights.

Aspect 13 is the first wireless device of any of aspects 11-12, where the first set of signals is a set of channel state information (CSI) reference signals (CSI-RSs) or a first set of sounding reference signals (SRSs), and where the second set of signals is a second set of SRS.

Aspect 14 is the first wireless device of any of aspects 11-13, where the feedback information is associated with a set of complex scalars, where each complex scalar of the set of complex scalars is based on a first beamforming vector associated with the respective antenna element of the first plurality of antenna elements, a channel associated with the communication link, and a second beamforming vector associated with a respective antenna element of the second plurality of antenna elements.

Aspect 15 is the first wireless device of any of aspects 11-13, where the first wireless device is a first network entity or a first user equipment (UE), and where the second wireless device is a second network entity or a second UE.

Aspect 16 is the first wireless device of any of aspects 11-15, where the at least one processor is configured to: establish a second communication link with a third wireless device, where the third wireless device includes a third plurality of antenna elements of a third quantity; and for each respective antenna element of the first plurality of antenna elements: cause transmission, to the third wireless device based on a second weight associated with the respective antenna element, of a third set of signals, where a fifth quantity of signals in the third set of signals is equal to the third quantity; receive, from the third wireless device, a fourth set of signals, where a sixth quantity of signals in the second set of signals is equal to the third quantity, and where the fourth set of signals is based on a second set of weights respectively associated with the third plurality of antenna elements; and cause transmission, to the third wireless device, of second feedback information associated with the fourth set of signals and information indicative of the second weight and the second set of weights.

Aspect 17 is the first wireless device of aspect 16, where the third set of signals is a third set of sounding reference signals (SRS), and where the fourth set of signals is a fourth set of SRS.

Aspect 18 is the first wireless device of any of aspects 16-17, where the second feedback information is associated with a second set of complex scalars, where each complex scalar of the second set of complex scalars is based on a third beamforming vector associated with the respective antenna element of the first plurality of antenna elements, a channel associated with the second communication link, and a fourth beamforming vector associated with a respective antenna element of the third plurality of antenna elements.

Aspect 19 is the first wireless device of any of aspects 16-18, where the communication link or the second communication link is based on a configuration from a network entity.

Aspect 20 is the first wireless device of any of aspects 16-18, where the communication link or the second communication link is independent of a configuration from a network entity.

Aspect 21 is a first wireless device for wireless communication, including: a first plurality of antenna elements of a first quantity: a memory; and at least one processor coupled to the memory, where the at least one processor is configured to: establish a multicast session with a group of wireless devices, where each wireless device in the group of wireless devices includes a respective plurality of antenna elements of a respective quantity of antenna elements; cause transmission, to each wireless device in the group of wireless devices, of a set of signals, where the set of signals includes a group of subsets of signals, where each subset of signals in the group of subsets of signals is associated with a respective wireless device in the group of wireless devices, and where a respective quantity of signals in the respective subset of signals is equal to the respective quantity of antenna elements; receive, from each wireless device in the group of wireless devices, a second set of signals, where a fourth quantity of signals in the second set of signals is equal to the second quantity, and where the second set of signals is based on a respective set of weights respectively associated with the respective quantity of antenna elements; and cause transmission, to the second wireless device, of feedback information associated with the second set of signals and information indicative of the weight.

Aspect 22 is the first wireless device of aspect 21, where the at least one processor is configured to: determine, based on the second set of signals and the information indicative of the weight, a set of calibration adjustment parameters associated with the first plurality of antenna elements; and adjust, based on the set of calibration adjustment parameters, the set of weights.

Aspect 23 is the first wireless device of any of aspects 21-22, where the first set of signals is a set of channel state information (CSI) reference signals (CSI-RS) or a first set of sounding reference signals (SRS), and where the second set of signals is a second set of SRS.

Aspect 24 is the first wireless device of any of aspects 21-23, where the feedback information is associated with a set of complex scalars, where each complex scalar of the set of complex scalars is based on a first beamforming vector associated with the respective antenna element of the first plurality of antenna elements, a channel associated with the multicast session, and a second beamforming vector associated with a respective antenna element of a second plurality of antenna elements.

Aspect 25 is the first wireless device of any of aspects 21-24, where the first wireless device is a first network entity or a first user equipment (UE), and where each wireless device in the group of wireless devices is a second network entity or a second UE.

Aspect 26 is a method of wireless communication for implementing any of aspects 1 to 10.

Aspect 27 is an apparatus for wireless communication including means for implementing any of aspects 1 to 10.

Aspect 28 is a computer-readable medium (e.g., a non-transitory computer-readable medium) having code stored thereon that, when executed by an apparatus, causes the apparatus to implement any of aspects 1 to 10.

Aspect 29 is a method of wireless communication for implementing any of aspects 11 to 20.

Aspect 30 is an apparatus for wireless communication including means for implementing any of aspects 11 to 20.

Aspect 31 is a computer-readable medium (e.g., a non-transitory computer-readable medium) having code stored thereon that, when executed by an apparatus, causes the apparatus to implement any of aspects 11 to 20.

Aspect 32 is a method of wireless communication for implementing any of aspects 21 to 25.

Aspect 33 is an apparatus for wireless communication including means for implementing any of aspects 21 to 25.

Aspect 34 is a computer-readable medium (e.g., a non-transitory computer-readable medium) having code stored thereon that, when executed by an apparatus, causes the apparatus to implement any of aspects 21 to 25.

1. A first wireless device for wireless communication, comprising:
a first plurality of antenna elements of a first quantity;
a memory; and
at least one processor coupled to the memory, wherein the at least one processor is configured to:
establish a communication link with a second wireless device, wherein the second wireless device comprises a second plurality of antenna elements of a second quantity; and
for each respective antenna element of the first plurality of antenna elements:
cause transmission, to the second wireless device based on a weight associated with the respective antenna element, of a first set of signals, wherein a third quantity of signals in the first set of signals is equal to the second quantity;
receive, from the second wireless device, a second set of signals, wherein a fourth quantity of signals in the second set of signals is equal to the second quantity, and wherein the second set of signals is based on a set of weights respectively associated with the second plurality of antenna elements; and
cause transmission, to the second wireless device, of feedback information associated with the second set of signals and information indicative of the weight.

2. The first wireless device of claim 1, wherein the at least one processor is configured to:
determine, based on the second set of signals and the information indicative of the weight, a set of calibration adjustment parameters associated with the first plurality of antenna elements; and
adjust, based on the set of calibration adjustment parameters, the set of weights.

3. The first wireless device of claim 1, wherein the first set of signals is a set of channel state information (CSI) reference signals (CSI-RSs) or a first set of sounding reference signals (SRSs), and wherein the second set of signals is a second set of SRS.

4. The first wireless device of claim 1, wherein the feedback information is associated with a set of complex scalars, wherein each complex scalar of the set of complex scalars is based on a first beamforming vector associated with the respective antenna element of the first plurality of antenna elements, a channel associated with the communication link, and a second beamforming vector associated with a respective antenna element of the second plurality of antenna elements.

5. The first wireless device of claim 1, wherein the first wireless device is a first network entity or a first user equipment (UE), and wherein the second wireless device is a second network entity or a second UE.

6. The first wireless device of claim 1, wherein the at least one processor is configured to:
establish a second communication link with a third wireless device, wherein the third wireless device comprises a third plurality of antenna elements of a third quantity; and
for each respective antenna element of the first plurality of antenna elements:
cause transmission, to the third wireless device based on a second weight associated with the respective antenna element, of a third set of signals, wherein a fifth quantity of signals in the third set of signals is equal to the third quantity;
receive, from the third wireless device, a fourth set of signals, wherein a sixth quantity of signals in the second set of signals is equal to the third quantity, and wherein the fourth set of signals is based on a second set of weights respectively associated with the third plurality of antenna elements; and
cause transmission, to the third wireless device, of second feedback information associated with the fourth set of signals and information indicative of the second weight and the second set of weights.

7. The first wireless device of claim 6, wherein the third set of signals is a third set of sounding reference signals (SRSs), and wherein the fourth set of signals is a fourth set of SRS.

8. The first wireless device of claim 6, wherein the second feedback information is associated with a second set of complex scalars, wherein each complex scalar of the second set of complex scalars is based on a third beamforming vector associated with the respective antenna element of the first plurality of antenna elements, a channel associated with the second communication link, and a fourth beamforming vector associated with a respective antenna element of the third plurality of antenna elements.

9. The first wireless device of claim 6, wherein the communication link or the second communication link is based on a configuration from a network entity.

10. The first wireless device of claim 6, wherein the communication link or the second communication link is independent of a configuration from a network entity.

11. A first wireless device for wireless communication, comprising:
a first plurality of antenna elements of a first quantity, wherein is respectively associated with a respective beam;
a memory; and
at least one processor coupled to the memory, wherein the at least one processor is configured to:
establish a communication link with a second wireless device, wherein the second wireless device comprises a second plurality of antenna elements of a second quantity; and
for each respective antenna element of the second plurality of antenna elements:
receive, from the second wireless device based on a weight associated with the respective antenna element, a first set of signals, wherein a third quantity of signals in the first set of signals is equal to the first quantity;
cause transmission, to the second wireless device, of a second set of signals, wherein a fourth quantity of signals in the second set of signals is equal to the first quantity, and wherein the second set of signals is based on a set of weights respectively associated with the first plurality of antenna elements; and
receive, from the second wireless device, feedback information associated with the second set of signals and information indicative of the weight.

12. The first wireless device of claim 11, wherein the at least one processor is configured to:
determine, based on the feedback information and the information indicative of the weight, a set of calibration adjustment parameters associated with the first plurality of antenna elements; and
adjust, based on the set of calibration adjustment parameters, the set of weights.

13. The first wireless device of claim 11, wherein the first set of signals is a set of channel state information (CSI) reference signals (CSI-RSs) or a first set of sounding reference signals (SRSs), and wherein the second set of signals is a second set of SRS.

14. The first wireless device of claim 11, wherein the feedback information is associated with a set of complex scalars, wherein each complex scalar of the set of complex scalars is based on a first beamforming vector associated with the respective antenna element of the first plurality of antenna elements, a channel associated with the communication link, and a second beamforming vector associated with a respective antenna element of the second plurality of antenna elements.

15. The first wireless device of claim 11, wherein the first wireless device is a first network entity or a first user equipment (UE), and wherein the second wireless device is a second network entity or a second UE.

16. The first wireless device of claim 11, wherein the at least one processor is configured to:
establish a second communication link with a third wireless device, wherein the third wireless device comprises a third plurality of antenna elements of a third quantity; and
for each respective antenna element of the first plurality of antenna elements:
cause transmission, to the third wireless device based on a second weight associated with the respective antenna element, of a third set of signals, wherein a fifth quantity of signals in the third set of signals is equal to the third quantity;
receive, from the third wireless device, a fourth set of signals, wherein a sixth quantity of signals in the second set of signals is equal to the third quantity, and wherein the fourth set of signals is based on a second set of weights respectively associated with the third plurality of antenna elements; and cause transmission, to the third wireless device, of second feedback information associated with the fourth set of signals and information indicative of the second weight and the second set of weights.

17. The first wireless device of claim 16, wherein the third set of signals is a third set of sounding reference signals (SRS), and wherein the fourth set of signals is a fourth set of SRS.

18. The first wireless device of claim 16, wherein the second feedback information is associated with a second set of complex scalars, wherein each complex scalar of the second set of complex scalars is based on a third beamforming vector associated with the respective antenna element of the first plurality of antenna elements, a channel associated with the second communication link, and a fourth beamforming vector associated with a respective antenna element of the third plurality of antenna elements.

19. The first wireless device of claim 16, wherein the communication link or the second communication link is based on a configuration from a network entity.

20. The first wireless device of claim 16, wherein the communication link or the second communication link is independent of a configuration from a network entity.

21-30. (canceled)
